(19) United States
(12) Patent Application Publication
(10) Pub. No.: US 2026/0083119 A1
(43) Pub. Date: Mar. 26, 2026

(54) PRESERVATION DEVICE FOR TRANSPLANTATION

(71) Applicant: Diatiro, Inc., San Francisco, CA (US)

(72) Inventors: Keith Samuel Hansen, San Francisco, CA (US); Darja Wendel, San Francisco, CA (US); Elger Oberwelz, San Francisco, CA (US); Jörg Student, Munich (DE); Kyle Hartelt, San Francisco, CA (US)

(21) Appl. No.: 19/408,122

(22) Filed: Dec. 3, 2025

Related U.S. Application Data
(63) Continuation-in-part of application No. PCT/US2025/031073, filed on May 27, 2025.
(60) Provisional application No. 63/652,162, filed on May 27, 2024.
(60) Provisional application No. 63/856,046, filed on Aug. 1, 2025.

(51) Int. Cl. A01N 1/144

(52) U.S. Cl. CPC A01N 1/144

(57) ABSTRACT

An organ support system can include outer wall structures defining an inner cavity and a proximal opening. The outer wall structures can include: first and second oblong wall members including an outer convex surface, an inner concave surface defining a portion of the inner cavity, and first and second ends; and first and second endcap wall members including an outer surface and an inner concave surface defining an endcap cavity, wherein the endcap cavity of the first endcap wall member can receive the first end of the first oblong wall member and the second end of the second oblong wall member, and the endcap cavity of the second endcap wall member can receive the second end of the first oblong wall member and the first end of the second oblong wall member. The oblong housing assembly can additionally include a tether structure.

### RELATED APPLICATIONS

This application is a) a Continuation of pending international provisional application number PCT/US2025/031073 filed under the Patent Cooperation Treaty on 27 May 2025, which claims benefit to U.S. Provisional Application No. 63/652,162 filed on 27 May 2024, and b) claims benefit under 35 U.S.C. § 119 (e) to U.S. Provisional Application No. 63/856,046, filed on Aug. 1, 2025, the contents of which applications are incorporated herein by reference in their entirety.

### FIELD

The described examples relate generally to apparatuses, methods, and systems that include a preservation device for medical transplantation (e.g., organ transplantation).

### BACKGROUND

Kidney transplantation is the best current treatment for kidney failure. However, 20%-30% of kidney transplant patients experience delayed graft function (DGF), which is defined as a transplant recipient requiring dialysis within seven days of transplantation surgery. Patients that develop delayed graft function have shorter graft survival by an estimated 3-year to 5-year half-life. Early graft loss in these patients often means a return to long-term dialysis and increased morbidity from continued immunosuppression therapy or transplantectomy without the benefits of transplantation. Kidney allograft warming above the threshold of necrosis can begin as early as 10 minutes into the surgical anastomosis. This period, called the “warm ischemia time” or “anastomosis time,” can be a key contributor to DGF and is often dependent on surgeon skills, allograft anatomy, and patient anatomy.

Certain devices for improving transplantation have been introduced in recent years. Unfortunately, adoption rates across the medical industry have been low because such devices suffer from various drawbacks. One drawback is a bulky spatial footprint that limits the already highly constrained surgical workspace during sew-in (e.g., about 1.5 inches of workspace). Other drawbacks can additionally or alternatively include, for instance, undesired coolant tubing, surgical workflow inhibitive, slow and/or difficult application/release of the organ, unsuitability for organ size/shape variation, incompatibility with robotic surgery, failure to maintain a threshold organ temperature, and/or incapable of cooling the organ throughout sew-in. Current cooling methods instead include methods such as wrapping ice around the organ using gauze and securing it with surgical hemostats or clips. These methods, however, cannot be reliably lifted, positioned, or removed with robotic arms. Therefore, there is an ongoing need for improving transplantation.

The subject matter claimed herein is not limited to examples that solve any disadvantages or that operate only in environments such as those described above. Rather, this background is only provided to illustrate one example technology area where some examples described herein may be practiced.

### SUMMARY

An aspect of the present disclosure relates an organ support system. The organ support system can include an oblong housing assembly that includes: a plurality of outer wall structures defining an inner cavity and a proximal opening; a longitudinal axis extending lengthwise through the oblong housing assembly; a first transverse axis orthogonal to the longitudinal axis, and comprising a distal direction and a proximal direction, the first transverse axis intersecting the proximal opening; and a second transverse axis orthogonal to the longitudinal axis and the first transverse axis. The plurality of outer wall structures can include: first and second oblong wall members, each oblong wall member including an outer convex surface, an inner concave surface defining a portion of the inner cavity, and first and second ends located at opposite sides of the longitudinal axis of the oblong housing assembly; and first and second endcap wall members, wherein each endcap wall member includes an outer surface and an inner concave surface defining an endcap cavity, wherein the endcap cavity of the first endcap wall member is configured to receive the first end of the first oblong wall member and the second end of the second oblong wall member, and the endcap cavity of the second endcap wall member is configured to receive the second end of the first oblong wall member and the first end of the second oblong wall member. The oblong housing assembly can additionally include a tether structure that interconnects: the first oblong wall member to the second oblong wall member; the first oblong wall member to the first endcap wall member; and the second oblong wall member to the second endcap wall member. In another embodiment the organ support system further comprises a tray with first recess configured to receive the first endcap wall member and the first oblong wall member, and a second recess configured to receive the second endcap wall member and the second oblong wall member.

In some examples, the inner cavity is configured to receive a kidney, and wherein the proximal opening is configured for passthrough of kidney hilar portions. In certain examples, the tether structure comprises a first arm attached to the first oblong wall member and a second arm attached to the second oblong wall member. In at least one example, the first arm is further attached to the first endcap wall member and the second arm is further attached to the second endcap wall member. In particular examples, the first arm is fixedly attached to the first oblong wall member and movably attached to the first endcap wall member.

In one or more examples, the first endcap wall member comprises an arm opening through which the first arm slidably passes through. In some examples, the first arm is attached to the first oblong wall member at a first attachment site spaced away from the first end of the first oblong wall member. In certain examples, the first attachment site is located at the inner concave surface of the first oblong wall member. In at least one example, the tether structure further comprises a hub, and wherein the first and second arms of the tether structures extend from the hub. In specific implementations, the tether structure further comprises a suspension arm extending from the hub, wherein when the suspension arm is raised, the organ support system is suspended in air. In some examples, the tether structure comprises a ribbon structure.

In some examples, the first and second endcap wall members comprises front and back edges that are non-parallel and non-orthogonal to at least one of the first transverse axis or the longitudinal axis. In certain examples, proximal regions of the front edges of the first and second endcap wall members are spaced farther apart from the first transverse axis than distal regions of the front edges of the first and second endcap wall members. In particular examples, the oblong housing assembly is size adjustable along multiple axes.

In one or more examples, the first and second oblong wall members each comprise a cooling structure comprising an outer convex surface complementary to the inner concave surface of the corresponding oblong wall member, and an inner concave surface. In some examples, the first and second oblong wall members each further comprise an inner contact structure, the inner contact structure comprising an outer convex surface complementary to the inner concave surface of the corresponding cooling structure, and a concave surface configured to contact an organ located in the inner cavity. In certain examples, the cooling structure includes a phase-change material. In particular examples, the first and second oblong wall members and the first and second endcap wall members each comprise a closed cell foam.

In some examples, the oblong housing assembly further includes a handle extending out from opposing end portions of the plurality of outer wall structures. In certain examples, the oblong housing assembly further includes an attachable strap member removably attachable to at least one of the first or second oblong wall members. In one example, in a secured configuration, the attachable strap members each comprise an orientation that is non-orthogonal to the longitudinal axis and the first transverse axis. In specific implementations, upon releasing the attachable strap members from a secured configuration, the first and second endcap members are configured to radially rotate toward the distal direction and expand the proximal opening. In at least one example, in the secured configuration, the attachable strap members are configured to partially cover the proximal opening.

Other aspects of the disclosure relate to systems, methods, and additional apparatuses. For example, other aspects of the present disclosure relate to a method of cooling an organ using an organ support system.

In another embodiment, a method of opening an organ support device, comprising separating complementary shell portions apart from one other at least as a result of application of gravitational force at the shell portions thereby causing a greater portion of the organ to be revealed from the housing for reperfusion. The complementary shell portions may be radially separated apart from one another at least as a result of the application of the gravitational force at the shell portions. The complementary shell portions may be radially separated apart from one another at least as a result of the application of the gravitational force at the shell portions and without exerting axial compression on the anastomosed vessels via the complementary shell portions.

In another embodiment, a method of robotically exposing a transplant organ contained in an organ-preservation housing, the housing including (i) a suspension lanyard affixed to opposed shell portions and (ii) at least one releasable closure strap secured to an outer wall, the method comprising (a) introducing the housing into a recipient's abdominal cavity and positioning the housing adjacent iliac vessels, (b) gripping the suspension lanyard with a first robotic arm and maintaining that grip, (c) with a second robotic arm, engaging a manipulation feature of the housing, (d) with the same second robotic arm and without transferring the housing to any other instrument, applying a peeling or separation force that detaches the closure strap from the outer wall, (e) completing detachment of the closure strap using the same second robotic arm while the first robotic arm continues to stabilize the housing via the lanyard, and (f) permitting the shell portions to separate radially under gravitational force, thereby revealing the organ for reperfusion without exerting axial compression on the anastomosed vessels. The second robotic arm may peel a first end of the strap with a first jaw orientation and, without releasing the strap, rotates its wrist joint to peel a remaining portion of the strap with a second jaw orientation. The manipulation feature may be a closed shape having an average internal diameter of 6-12 mm. The method may further comprise extracting the empty housing through a single access port with the first robotic arm still gripping the lanyard. The closure strap may include a radiopaque indicator that remains visible on post-procedure fluoroscopy to confirm complete removal.

An aspect of the present disclosure relates to an organ or tissue preservation device. The organ preservation device can include a first shell half and a second shell half configured to enclose a kidney, the first shell half and the second shell half each comprising a first terminal end at a hilar access window, a second terminal end opposite the hilar access window, and two lateral sides; a first attachable strap member coupled to one of the first shell half or the second shell half; a second attachable strap member coupled to the other of the first shell half or the second shell half; a tether structure connecting the first shell half and the second shell half at the first ends, the tether structure configured to be lifted by a robotic or manual instrument; two handles, one handle coupled to each lateral side, the two handles configured to be grasped by a robotic actuator; and a release mechanism configured such that detachment of the first attachable strap and the second attachable strap via an outward force applied to the handle or tether structure permit the first shell half and the second shell half to move radially apart under gravity or external bias while remaining joined by the tether structure.

In some examples, each handle is a continuous ring without free ends. In certain examples, lifting the tether structure orients the hilar access window downward under gravity. In at least one example, the release first attachable strap and the second attachable strap comprises hook-and-loop straps. In particular examples, the organ preservation device further includes phase-change material positioned within each of the first shell half and the second shell half to maintain a kidney temperature between 1° C. and 7° C. In some examples, the two handles are symmetrically spaced about a longitudinal axis of the device. In at least one example, the tether structure and the two handles comprise a biocompatible polymer material or a metal material capable of withstanding at least 10 N tensile load. In certain examples, a system comprising the organ preservation device and a first robotic arm gripping the tether structure and a second robotic arm gripping at least one of the two handles.

In another embodiment, a method of robotic-assisted transplantation includes enclosing a kidney within an organ preservation device, the organ preservation device comprising; lifting the organ preservation device via the tether structure with a first robotic arm; grasping the two handles with a second robotic arm; detaching the first attachment strap and the second attachment strap using the second arm; and radially separating the first shell half and the second shell half to expose a hilum of the kidney. In some examples, the organ preservation device includes a first shell half and a second shell half configured to enclose a kidney, the first shell half and the second shell half defining a hilar access window and an end opposite the hilar access window, a flexible tether structure connecting respective ends of the first shell half and the second shell half, the tether structure configured to be lifted by a robotic or manual instrument; a first attachable strap member coupled to one of the first shell half or the second shell half; a second attachable strap member coupled to the other of the first shell half or the second shell half; two handles, one handle on each lateral side of the device configured to be grasped by a robotic actuator; and a release mechanism configured such that detachment of the first attachable strap and the second attachable strap via an outward force to the two handles or the tether structure permits the first shell half and the second shell half to move radially apart under gravity or external bias while remaining joined by the tether structure. In particular examples, gravity draws the kidney downward as the first shell half and the second shell half part.

In another embodiment, a packaging system for pre-cooling an organ-preservation housing can include: a tray having a first compartment shaped to receive an organ preservation device and a second compartment; and a phase-change material insert positioned in the second compartment, the removable phase-change material insert configured to transfer heat from the organ preservation device when the organ preservation device is in thermal contact with the first compartment.

In some examples, the phase-change material insert comprises a melt temperature between 3° C. and 5° C. In at least one example, the first compartment includes a thermally conductive film that is configured to at least partially contact an organ-preservation housing. In another example, the system can further include a sterile barrier pouch enclosing the tray. In particular examples, the tray comprises a high-density polyethylene and the phase-change material insert is removable. In some examples, the system can further include an insulated transport sleeve containing one or more phase-change material inserts surrounding the tray. In some examples, a kit can include the packaging system for pre-cooling an organ-preservation housing, the organ-preservation housing, and at least one closure strap.

In still another embodiment, a method of preparing an organ-preservation housing can include (a) placing an organ-preservation housing in thermal contact with a phase-change material insert within a tray; (b) waiting a dwell time until a temperature indicator confirms the organ-preservation housing temperature is 6° C. or lower; (c) transferring a kidney into the organ-preservation housing; and (d) closing the organ-preservation housing around the kidney and performing vascular anastomosis.

In some examples, step (b) comprises a dwell time of 5 to 10 minutes. In at least one example, the method further includes removing the phase-change material insert from the tray after step (b). In another example, the organ-preservation housing maintains the kidney temperature between 1° C. and 7° C. for at least 60 minutes following step (d), In particular examples, the method can also include confirming a color change of a thermal-battery indicator prior to step (c).

In still another embodiment, an ornamental design for a kidney support device as shown and described is provided. In some embodiments, the ornamental design is as shown in described in FIG. 13-36, 13-20, 21-28 or 19-36. Other technical features may be apparent to one skilled in the art, having the benefit of this disclosure, in connection with the following figures, descriptions, and claims. Further, the subject matter claimed herein is not limited to embodiments that solve any disadvantages or that operate only in environments such as those described above. Rather, this summary section is only provided to illustrate certain feature and embodiments.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A illustrates a front plan view of an organ support system in a closed, secured configuration in accordance with one or more examples of the present disclosure;

FIG. 1B illustrates a front plan view of an organ support system in a closed, unsecured configuration in accordance with one or more examples of the present disclosure;

FIG. 1C illustrates a front plan view of an organ support system in released configuration in accordance with one or more examples of the present disclosure;

FIG. 2A illustrates a front plan view of an organ support system in a closed, secured configuration in accordance with one or more examples of the present disclosure;

FIG. 2B illustrates a rear plan view of an organ support system in a closed, secured configuration in accordance with one or more examples of the present disclosure;

FIG. 2C illustrates a side plan view of an organ support system in a closed, secured configuration in accordance with one or more examples of the present disclosure;

FIG. 2D illustrates another side plan view (opposite the side plan view of FIG. 2C) of an organ support system in a closed, secured configuration in accordance with one or more examples of the present disclosure;

FIG. 2E illustrates a top (distal) plan view of an organ support system in a closed, secured configuration in accordance with one or more examples of the present disclosure;

FIG. 2F illustrates a bottom (proximal) plan view of an organ support system in a closed, secured configuration in accordance with one or more examples of the present disclosure;

FIG. 2G illustrates a perspective view of an organ support system in a closed, secured configuration in accordance with one or more examples of the present disclosure;

FIG. 2H illustrates an exploded view of an organ support system in accordance with one or more examples of the present disclosure;

FIG. 3A illustrates a front plan view of an organ support system in an open configuration in accordance with one or more examples of the present disclosure;

FIG. 3B illustrates a rear plan view of an organ support system in an open configuration in accordance with one or more examples of the present disclosure;

FIG. 3C illustrates a side plan view of an organ support system in an open configuration in accordance with one or more examples of the present disclosure;

FIG. 3D illustrates a bottom (proximal) plan view of a constituent portion of an organ support system in accordance with one or more examples of the present disclosure;

FIG. 3E illustrates a top (distal) plan view of a constituent portion of an organ support system in accordance with one or more examples of the present disclosure;

FIG. 3F illustrates a perspective view of an organ support system in an open configuration in accordance with one or more examples of the present disclosure;

FIG. 3G illustrates a cross-sectional view along a longitudinal axis of a constituent portion of an organ support system in accordance with one or more examples of the present disclosure;

FIG. 3H illustrates a cross-sectional view along a first transverse axis of a constituent portion of an organ support system in accordance with one or more examples of the present disclosure;

FIG. 4A illustrates a front perspective view of an inner contact structure in accordance with one or more examples of the present disclosure;

FIG. 4B illustrates a rear perspective view of an inner contact structure in accordance with one or more examples of the present disclosure;

FIG. 4C illustrates a top (distal) plan view of an inner contact structure in accordance with one or more examples of the present disclosure;

FIG. 5A illustrates a front perspective view of an oblong wall member in accordance with one or more examples of the present disclosure;

FIG. 5B illustrates a rear perspective view of an oblong wall member in accordance with one or more examples of the present disclosure;

FIG. 5C illustrates a distal perspective view of an oblong wall member with an endcap wall member in accordance with one or more examples of the present disclosure;

FIG. 6A illustrates a perspective view of an endcap wall member in accordance with one or more examples of the present disclosure;

FIG. 6B illustrates another perspective view of an endcap wall member in accordance with one or more examples of the present disclosure;

FIG. 7A illustrates a perspective view of a cooling structure in accordance with one or more examples of the present disclosure;

FIG. 7B illustrates a top (distal) plan view of a cooling structure in accordance with one or more examples of the present disclosure;

FIG. 7C illustrates a cross-sectional view along a longitudinal axis of a cooling structure in accordance with one or more examples of the present disclosure;

FIG. 7D illustrates a cross-sectional view along a first transverse axis of a cooling structure in accordance with one or more examples of the present disclosure;

FIGS. 8A-8D illustrate an example method flow of retaining an organ to cool within another example implementation of an organ support system, in accordance with one or more examples of the present disclosure;

FIG. 8E illustrates a top (distal) plan view of the organ support system of FIGS. 8A-8F, in accordance with one or more examples of the present disclosure;

FIG. 8F illustrates a close-up view of an endcap wall member portion of the organ support system of FIGS. 8A-8F, in accordance with one or more examples of the present disclosure;

FIGS. 9A-9F illustrate an example method flow of retaining an organ to cool within an organ support system, in accordance with one or more examples of the present disclosure;

FIG. 10 illustrates an example method flow of utilizing an organ support system in accordance with one or more examples of the present disclosure;

FIG. 11 illustrates—in relation to the current standard of care and certain conventional devices—experimental data of utilizing an organ support system in accordance with one or more examples of the present disclosure; and

FIG. 12A illustrates a package including an organ support system of the present disclosure; FIG. 12B illustrates an exploded version of a package including an organ support system of the present disclosure; FIG. 12C illustrates a cross-section of the package including the organ support system; FIGS. 12D and 12E depict another exemplary method of preparing and using the organ support system during an anastomosis procedure.

FIG. 13 is a top perspective view of an organ support device;

FIG. 14 is a bottom perspective view of the organ support device;

FIG. 15 is a front view of the organ support device;

FIG. 16 is a back view of the organ support device;

FIG. 17 is a left side view of the organ support device;

FIG. 18 is a right side view of the organ support device;

FIG. 19 is a top plan view of the organ support device; and

FIG. 20 is a bottom plan view of the organ support device.

FIG. 21 is a top perspective view of an organ support device;

FIG. 22 is a bottom perspective view of the organ support device;

FIG. 23 is a front view of the organ support device;

FIG. 24 is a back view of the organ support device;

FIG. 25 is a left side view of the organ support device;

FIG. 26 is a right side view of the organ support device;

FIG. 27 is a top plan view of the organ support device; and

FIG. 28 is a bottom plan view of the organ support device.

FIG. 29 is a top perspective view of an organ support device;

FIG. 30 is a bottom perspective view of the organ support device;

FIG. 31 is a front view of the organ support device;

FIG. 32 is a back view of the organ support device;

FIG. 33 is a left side view of the organ support device;

FIG. 34 is a right side view of the organ support device;

FIG. 35 is a top plan view of the organ support device; and

FIG. 36 is a bottom plan view of the organ support device.

The broken lines are for illustrative purposes only and form no part of the claimed design.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described examples as defined by the appended claims.

The following disclosure relates to an organ cooling device (also referred to herein as an organ or tissue support device, organ or tissue support system, or an organ or tissue preservation device) designed to maintain the organ at a cooled temperature during transplantation. The organ cooling device can include insulative components and cooling structures for thermal regulation. The organ cooling device is low profile and conforms well to a variety of different organ shapes and sizes for increased surface contact with the organ (and minimal air gaps). The organ cooling device can be robotically and/or manually manipulated via handles, tether structures, etc.

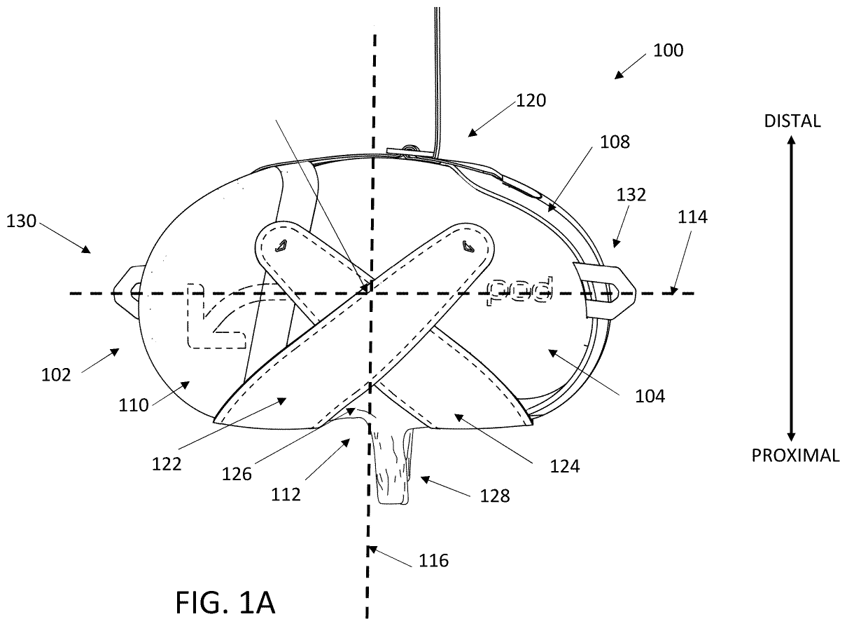

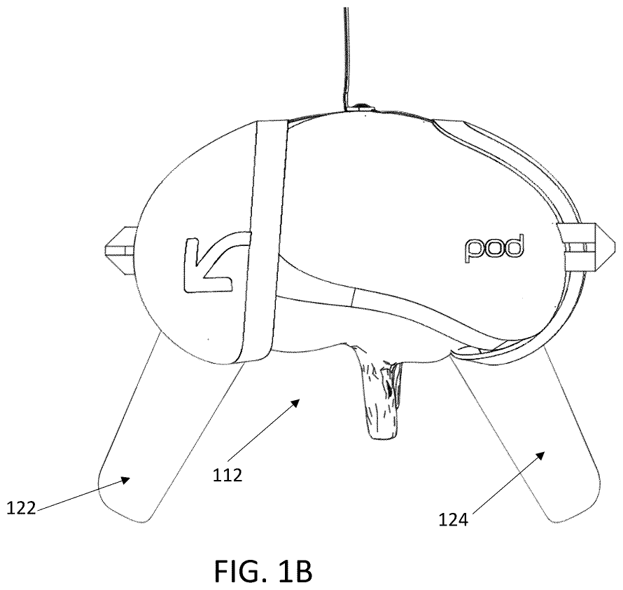

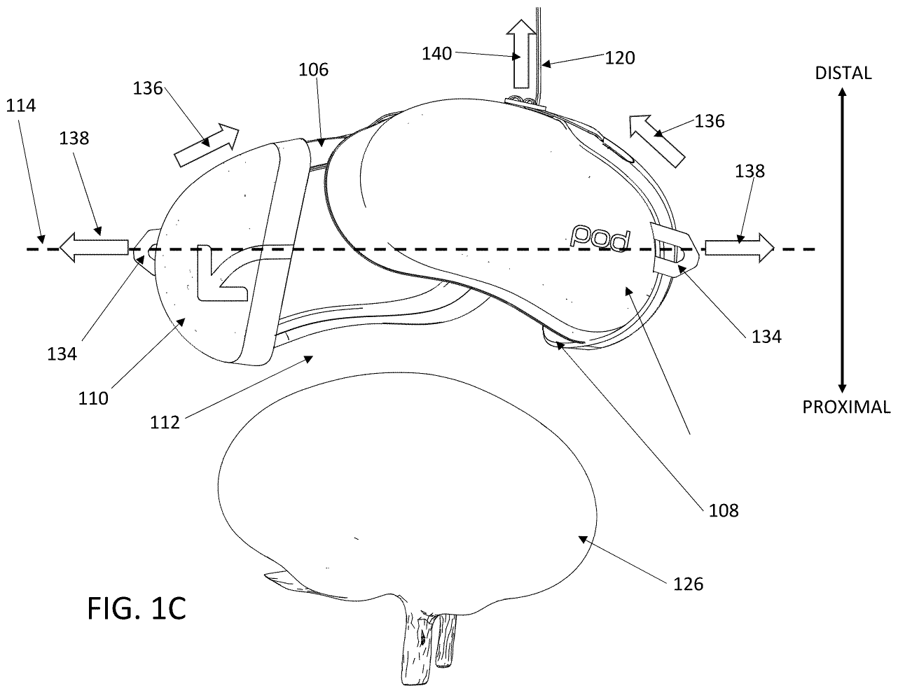

These and other examples are discussed below with reference to FIGS. 1A-12C. However, a person of ordinary skill in the art-having the benefit of this disclosure-will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1A-1C illustrate an organ support system 100 in accordance with one or more examples of the present disclosure. As discussed herein, the organ support system 100 can help facilitate organ transplantation. The structures of the disclosed organ support system 100 can be low-profile, easily integrated into a surgical workflow, and manipulated by robotic operation and/or surgeon technicians. In addition, the various disclosed structures of the organ support system 100 can provide a desired cooling of the organ throughout sew-in, as well as readily position, stabilize, and release the organ in a transplant procedure.

As shown, the organ support system 100 includes an oblong housing assembly 102. The oblong housing assembly 102 can include a plurality of outer wall structures defining an inner cavity sized and shaped to receive an organ. In addition, the plurality of outer wall structures can define a proximal opening 112. The plurality of outer wall structures are discussed in greater detail below. The organ support system 100 can include a longitudinal axis 114 extending lengthwise through the organ support system 100, a first transverse axis 116 extending height-wise through the organ support system 100, and a second transverse axis 118 extending width-wise (in and out of the page in FIG. 1A) through the organ support system 100. The first transverse axis 116 is orthogonal to the longitudinal axis 114 and defines a distal direction and a proximal direction. The second transverse axis 118 is orthogonal to the longitudinal axis 114 and the first transverse axis 116. These axes will be used to reference positional relationships of the various components of the organ support system 100.

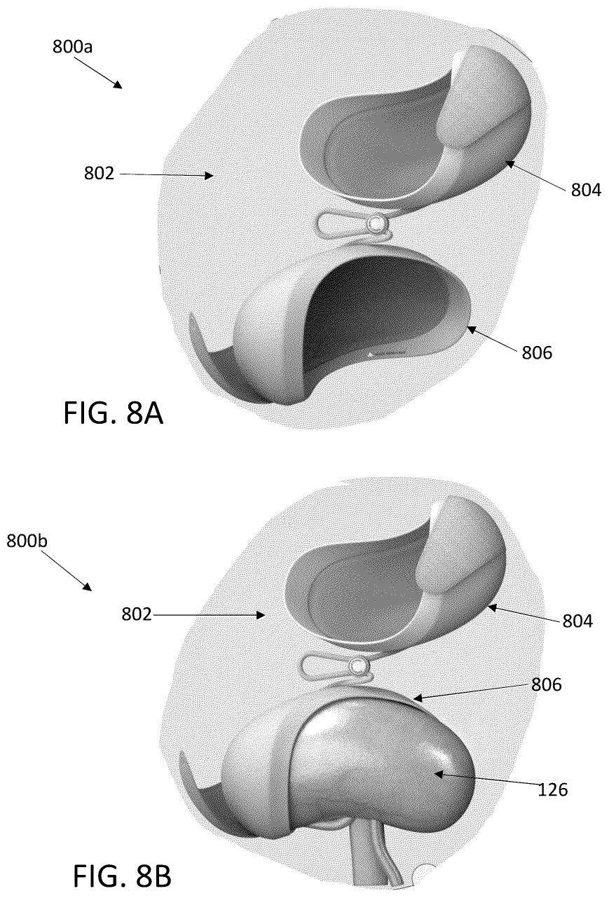

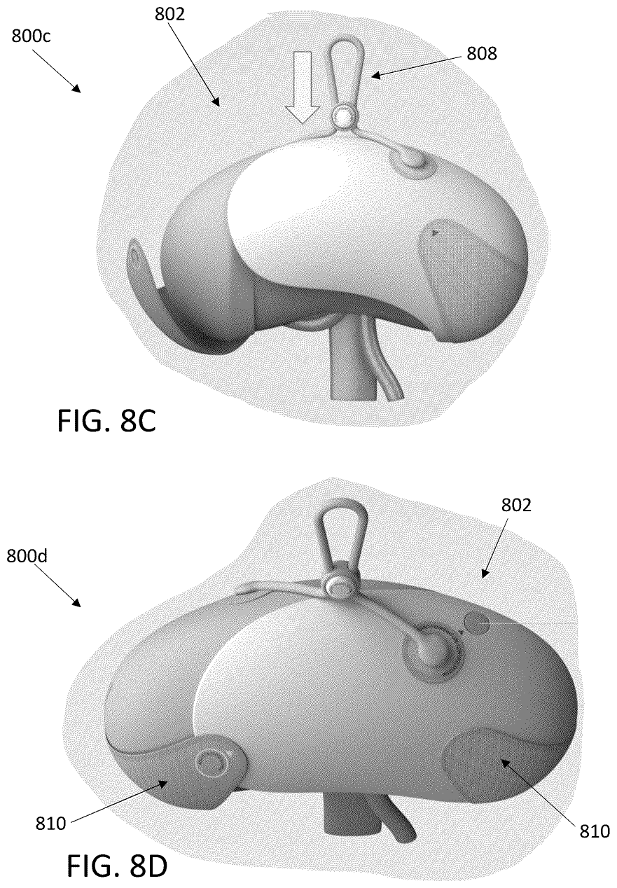

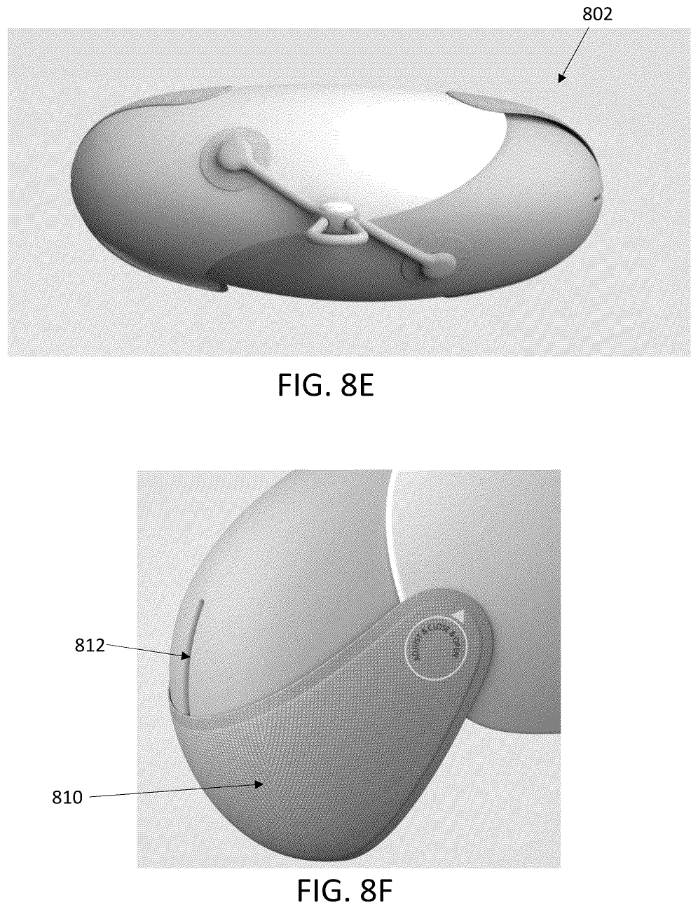

The plurality of outer wall structures can include a first oblong wall member 104, a second oblong wall member 106 (not shown in FIGS. 1A-1B), a first endcap wall member 108, and a second endcap wall member 110. In the depicted example, the plurality of outer wall structures can include separate and discrete portions. For instance, the first oblong wall member 104 and the first endcap wall member 108 can be discrete components. In other examples, however, such members or components can be integrally formed together as a single piece unit (e.g., as shown in FIGS. 8A-8F).

In particular examples, the plurality of outer wall structures work together or are otherwise complementary to each other to retain an organ. In some examples the plurality of outer wall structures are slid together, intermeshed with one another, folded or tucked into one another (e.g., origami-style), interlocked together, and/or are inserted into each other. In specific implementations, the plurality of outer wall structures are configured as shell halves that are entirely (or substantially) detachable from one another. In some further variations, the interrelationships between the outer wall structures may be variable, e.g., different degrees or amount of overlap, to accommodate organs of different sizes and shapes, while still maintaining sufficient or adequate surface contact with the organ to provide cooling. The variations may be along the longitudinal length, height, width and/or circumference of the outer wall structures.

As used herein, “overlap distance δ” refers to the linear amount by which one shell portion margin overlies, underlies, or intermeshes with the opposing shell portion margin in the closed configuration. The device is engineered to provide an adjustable overlap window. Accordingly, in an adult setting the overlap distance δ_L may range from approximately 8 mm to 45 mm, δ_H from 3 mm to 18 mm, and δ_W from 1 mm to 12 mm, corresponding to about 8-45%, 5-35%, and 3-25% of the respective shell dimensions; pediatric or xenograft applications may employ proportionally smaller values while still falling within these percentage ranges.

In these or other examples, the plurality of outer wall structures can include a variety of shapes and sizes. In certain examples, the plurality of outer wall structures are sized and shaped to accommodate a particular type of organ (e.g., a kidney). In at least one example, the plurality of outer wall structures when assembled can include an oblong shape, an egg shape, melon shape, etc. In at least some examples, the plurality of outer wall structures are size and/or shape adjustable. For instance, the plurality of outer wall structures can be adjusted (e.g., lengthened or shortened) along the longitudinal axis 114 to accommodate different length dimensions of a retained organ. Similarly, in some examples, the plurality of outer wall structures can be adjusted in height along the first transverse axis 116 to accommodate different height dimensions of a retained organ. By manipulating the overlap distances δL, δH, and δW within the foregoing quantitative ranges, the shell halves may be made to overlap or retract from one another to provide a custom fit for a given organ and/or reduce air gaps between the kidney 126 and the organ-support system 100. Likewise, in some examples, the plurality of outer wall structures can be adjusted in width along the second transverse axis 118 to accommodate different width dimensions of a retained organ. In such examples, the plurality of outer wall structures can be manipulated to overlap one another and/or retract from one another along the various axes to provide a custom fit for a given organ and/or reduce air gaps between the kidney 126 and the organ support system 100. Additionally or alternatively, the plurality of outer wall structures may be reconfigurable (e.g., pliant, bendable, reshapable, moldable, malleable, etc.). In one example, the plurality of outer wall structures can include shape memory.

The plurality of outer wall structures can include a variety of one or more different materials. In some examples plurality of outer wall structures can include a nonabsorbent, biocompatible material. For instance, the plurality of outer wall structures can include a foam material (e.g., a closed cell foam, open cell foam, aerogel or other porous material), metal, silicone, or combinations thereof. In one implementation, the first and second oblong wall members 104, 106 and the first and second endcap wall members 108, 110 each comprise a closed cell foam. In particular examples, the plurality of outer wall structures can include an insulative material to help limit heat transfer from one or more cooling structures inside the organ support system 100 into the ambient environment. For instance, the plurality of outer wall structures can include a closed-cell polyurethane foam with thermal conductivity not greater than 0.05 W·m⁻¹·K⁻¹. In at least one example, the plurality of outer wall structures can include nylon or polyethylene. In specific implementations, the plurality of outer wall structures can include an attachment material (e.g., at least one of a hook and loop material). In one example, the plurality of outer wall structures can include a shape memory material (e.g., Nitinol).

In addition to various materials, the plurality of outer wall structures can include one or more indicators. The indicators can include position indicators, orientation indicators, temperature indicators, time-lapse indicators, etc. Orientation indicators, for example, can be color-coded or depicted via symbols and/or alphanumeric characters (e.g., such that the organ is properly oriented within the organ support system 100 and/or to ensure proper placement of the organ support system 100 relative to the patient). In one example, an orientation indicator indicates which pole-end is the ureter pole 130 so that a ureter is properly oriented toward a patient's bladder. Temperature indicators can also be color-coded (e.g., to visually ensure thermal readiness of the organ support system 100).

The attachable strap members 122, 124 can maintain the organ support system 100 in a secured configuration. The attachable strap members 122, 124 can include straps, bands, tighteners, cinches, belts, etc. In some examples, the attachable strap members 122, 124 can include a hook and loop material securable to the plurality of outer wall structures. Additionally or alternatively, the attachable strap members 122, 124 can include fasteners (e.g., clasps, clips, buttons, ties, etc.). In some examples, the attachable strap members 122, 124 can be attached (e.g., removably or permanently) to at least one the plurality of outer wall structures, such as one of the first or second oblong wall members 104, 106. In at least one example, the attachable strap members 122, 124 include a fixed end permanently attached to one of the plurality of outer wall structures.

In these or other examples, the attachable strap members 122, 124 can secure an organ within the organ support system 100. Specifically, the attachable strap members 122, 124 can maintain the positional relationship of the plurality of outer wall structures relative to each other, thereby maintaining a desired fit or compression of the organ support system 100 about the retained organ. The attachable strap members 122, 124 can also at least partially cover or define the proximal opening 112 (e.g., for adjusting a size and/or shape of the proximal opening 112, for adjusting visualization of the hilar portions 128, etc.). In specific implementations, the attachable strap members 122, 124 can adjustably overlap each other or cross (e.g., in an X-configuration). In the depicted example of FIG. 1A showing a secured configuration of the organ support system 100, the attachable strap members 122, 124 can each include an orientation that is non-orthogonal to the longitudinal axis 114 and the first transverse axis 116.

Further shown in the secured configuration depicted in FIG. 1A when the organ (e.g., kidney 126) is retained within the organ support system 100, a proximal opening 112 can allow certain portions of the organ (e.g., hilar portions 128) to be accessed. For example, the proximal opening 112 can specifically enable anastomosis to be performed where the hilar portions 128 (renal vein and renal artery) extending through the proximal opening 112 are joined with the iliac vein and iliac artery—all while the kidney 126 is secured (and cooled) within the organ support system 100. In some examples, the tether structure 120 can suspend the kidney 126 enclosed within the organ support system 100 over the surgical site. In this example, gravity causes the proximal opening 112 to face downward, aligning the exposed hilar portions 128 within the proximal opening 112 with the surgical site while suspending the kidney 126 out of the way of the surgeon to enable anastomosis to be performed while keeping the kidney 126 secured and cooled.

The proximal opening 112 can include a variety of shapes and sizes. In specific examples, the proximal opening 112 is sized and shaped for passage of the hilar portions 128 therethrough. In one or more embodiments, a ureter can optionally pass through the proximal opening 112 (or else reside within the inner cavity with the kidney). Additionally or alternatively the proximal opening 112 can be sized and shaped for optimal minimization of heat transfer from the ambient environment to the kidney 126.

The proximal opening 112 can be positioned in various places. In some examples, the proximal opening 112 is positioned in a proximal region of the organ support system 100 opposite a tether structure 120. In certain examples, the proximal opening 112 is positioned between a ureter pole 130 and an upper pole 132 opposite the ureter pole 130 (the ureter pole 130 being a lower pole). In specific examples, the proximal opening 112 is positioned between the ureter pole 130 and the upper pole 132 such that the first transverse axis 116 can intersect the proximal opening 112.

In some examples, the oblong housing assembly 102 can additionally include a tether structure 120. The tether structure 120 can include one or more stay elements, hoist elements, suspension elements, positioning elements, connectors, etc. For example, the tether structure 120 can include a ribbon structure, such as a lanyard, rope, strap, band, belt, wire, etc.

In these or other examples, a tether structure 120 can couple certain portions of the oblong housing assembly 102 together. For example, the tether structure 120 can couple the first oblong wall member 104 to the second oblong wall member 106. The tether structure 120 can additionally or alternatively couple the first oblong wall member 1042 the first endcap wall member 108. The tether structure 120 can additionally or alternatively couple the second oblong wall member 106 to the second endcap wall member 110.

In some examples, the tether structure 120 can also be used to position, manipulate, orient, suspend, push, pull, and/or move the organ support system 100. In one or more examples, the tether structure 120 can be handled via robotic operation and/or human technician, as will be discussed in more detail below.

FIG. 1B shows an example of an unsecured configuration, in which the attachable straps 122, 124 are at least partially removed from the organ support system 100. For example, the attachable straps 122, 124 are at least partially unwrapped from covering the proximal opening 112. Accordingly, the proximal opening 112 can be increased or enlarged to expose more of a proximal portion of the kidney 126.

In some examples, a first robotic arm can grip, hold, lift, or lower the tether structure 120 while a second robotic arm can grip, hold, or otherwise secure one or more handles 134 positioned on the lateral edges of the organ support system 100. Additionally or alternatively, the second robotic arm, or a third robotic arm, can detach the attachable straps 122, 124, at least partially unwrapping the attachable straps 122, 124 from covering the proximal opening 112 by applying a force outward (in the +Y direction). In some examples, the attachable straps 122, 124 can be attached to the plurality of wall structures via hook-and-loop, and the robotic arm can peel the attachable straps 122, 124 away from the plurality of wall structures.

In some examples, when both attachable straps 122, 124 are detached, the only remaining connection between the shell halves is the tether structure 120. In particular examples, when the organ support system 100 is suspended by the tether structure 120 and both attachable straps 122, 124 are detached, gravity and/or the weight of each shell half can cause the shell halves to swing or translate radially outward. In this example, when the shell halves swing or translate radially outward, the overlap distance & decreases to zero, exposing the kidney 126 (or other organ) while the shell halves remain tethered together.

In FIG. 1C, the kidney 126 is released from the organ support system 100. Release of the kidney 126 (or other organ) can be achieved in various ways. In one example, handles 134 (e.g., loops, rings, notches, grips, eyelets, knobs, shafts, depressions, protrusions, etc.) can be utilized. In some examples, the handles 134 comprise a continuous ring defining an aperture. Handles 134, for instance, can extend out from opposing end portions of the plurality of wall structures and can be pulled apart in opposite directions (indicated by longitudinal arrows 138) along the longitudinal axis. Alternatively, only a single handle 134 can be pulled for single-handed actuation or release. Pulling one or both of the handles 134 in such a longitudinal fashion can increasingly enlarge the proximal opening 112 until the kidney 126 can fall through the proximal opening 112. In these or other examples, handles 134 can be pulled via robotic arms and/or human technicians.

In specific examples, however, handles 134 can be particularly sized and shaped to receive robotic grippers or robotic hooks (e.g., first and second robotic arms). In particular examples, the handles 134 can comprise a closed loop shape. In some examples, the handles 134 can comprise molded rings. An additional robotic arm (e.g., tertiary robot arm can hold, hoist, and/or lower the organ support system 100 into a desired position e.g., via the suspension arm discussed further below). Handles 134 can include various materials (e.g., webbing, rubber, metal, etc.) and can be rigid or non-rigid. The handle material can be configured to withstand at least 10 N tensile load. In at least one example, the handles 134 can be adapted to receive a threshold pulling force designed to separate the organ support system 100. In some examples, the handles can include suitable for a robotic gripper, such as an 8-mm robotic gripper. In these examples, the lack of free ends from a continuous ring loop can prevent accidental disengagement. In other examples, the tether structure 120 can serve as a clamp or retraction handle in open surgery for hands-free positioning in the surgical site. In this example, the handles 134 can act as manual grips. In both the mechanical or robotic implementations, when the attachable straps 122, 124 are detached and/or removed, the shell halves of the organ support system 100 radially open exposing more of the proximal portion of the kidney 126.

In another example, the kidney 126 can be released from the organ support system 100 with or without pulling the handles 134. Specifically, the kidney 126 can exit the proximal opening 112 due to the weight of the kidney 126 acting on the organ support system 100 when in the unsecured configuration. To illustrate, the weight of the kidney 126 can naturally impart a downward force upon one or more of the plurality of wall structures of the organ support system 100. In response to the weight of the kidney 126, various structures of the organ support system 100 can be gently displaced. Additionally or alternatively, one or more interior surfaces of the organ support system 100 can include a treated surface, smoothed surface, polished surface, reduced-friction coating, etc. satisfying a threshold coefficient of friction or surface roughness to help the kidney 126 easily slide out from the organ support system 100 (or the organ support system 100 to slide out from underneath the kidney 126). In these or other examples, the friction force imparted by the weight of the kidney 126 against an interior surface of the organ support system 100 (having a reduced coefficient of friction) can be less than the retraction force withdrawing the organ support system 100 (e.g., via the tether structure 120). A reduced friction treated interior surface (e.g., a polyurethane foam layer or coating) of the organ support system 100 can help prevent the kidney 126 from sticking or catching on the organ support system 100 during release, according to some examples.

In some examples, the various structures of the organ support system 100 can radially rotate toward the distal direction-specifically in the direction of radial arrows 136. By radially rotating in the direction of radial arrows 136, the proximal opening 112 can increasingly enlarge the proximal opening 112 until the kidney 126 can fall through the proximal opening 112. In specific implementations, upon releasing the attachable strap members 122, 124 from the secured configuration (shown in FIG. 1A), the first and second endcap members are configured to radially rotate toward the distal direction and expand the proximal opening 112 (e.g., in a controlled manner). In at least one example, releasing the attachable strap members 122, 124 from the secured configuration (shown in FIG. 1A) can allow the joined halves or constituent portions of the organ support system 102 to entirely separate—at which point the separated halves or portions may only be loosely coupled via the tether structure 120. Like cracking an egg, distal portions of the organ support system 100 can pivot (or swing) closer to each other while proximal portions of the organ support system 100 can pivot (or swing) away from each other to allow the kidney 126 to drop out. In some examples of this release process, the kidney 126 can retain its laid-down and unsuspended position relative to the surgical site, and the organ support system 100 can (as just described) move, flex, rotate, and/or translate its constituent portions as the organ support system 100 is gently pulled away from the kidney 126. In such an example, the organ support system 100 can slide out and/or break apart from retaining the kidney 126 to facilitate convenient release and pull-away in a manner that does not disturb the kidney 126 or otherwise compromise the newly applied sutures of the anastomosis site. Rather, the kidney 126 can maintain remain unmoved, and the organ support system 100 can displace itself/break apart from around the kidney 126 for release thereof. Generally, though, the overlapping of constituent portions of the organ support system 100 decreases during radial rotation for release of the kidney.

In yet another example, the foregoing gravity release of the kidney 126 can be aided by pulling the tether structure 120 in the distal direction indicated by distal arrow 140. To illustrate, the organ support system 100 can undergo a greater normal force in response to the combination of an upward force (or acceleration) in the direction of the distal arrow 140 and the downward force from the weight of the kidney 126. The gravity-aided release can be implemented in either surgical method, whether the organ support system 100 is suspended in air or laid to rest on top of the patient. That is, with either approach, the kidney can fall or slip out during release as the organ support system 100 is retracted away from the surgical site using the tether structure 120. When in the unsecured configuration, the organ support system 100 does not provide this resultant normal force and thus is forcefully rotated in the radial fashion along radial arrows 136, as discussed above.

Any of the features, components, and/or parts, including the arrangements and configurations thereof shown in FIGS. 1A-1C can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 1A-1C.

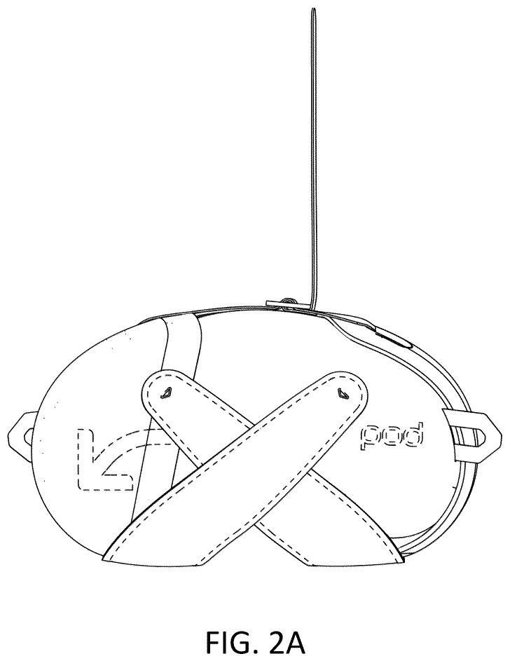

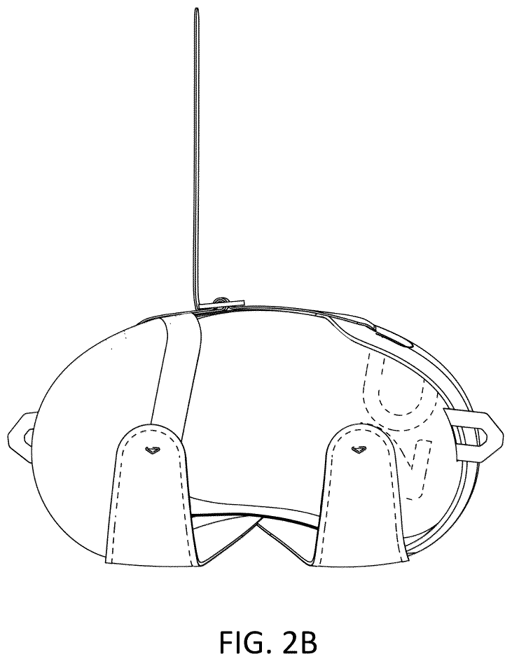

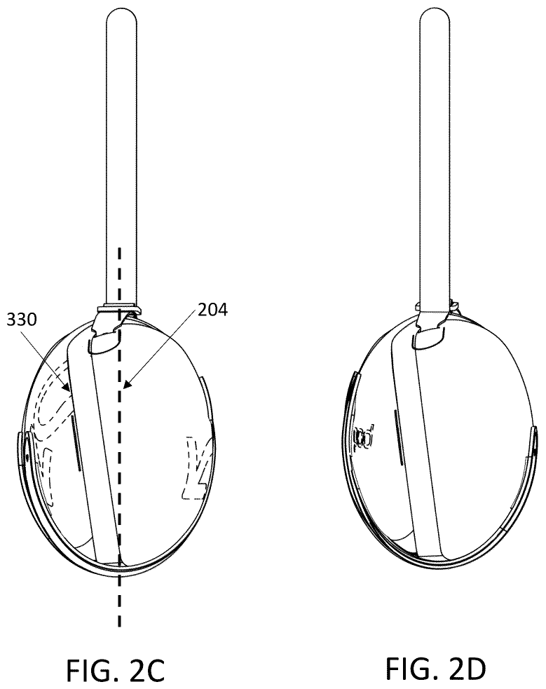

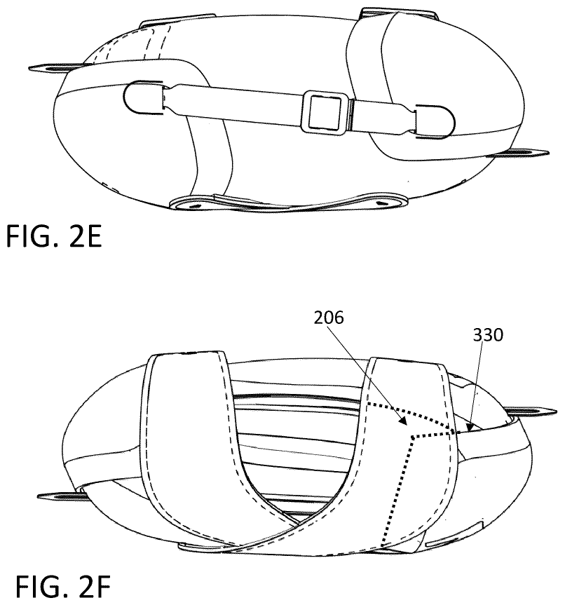

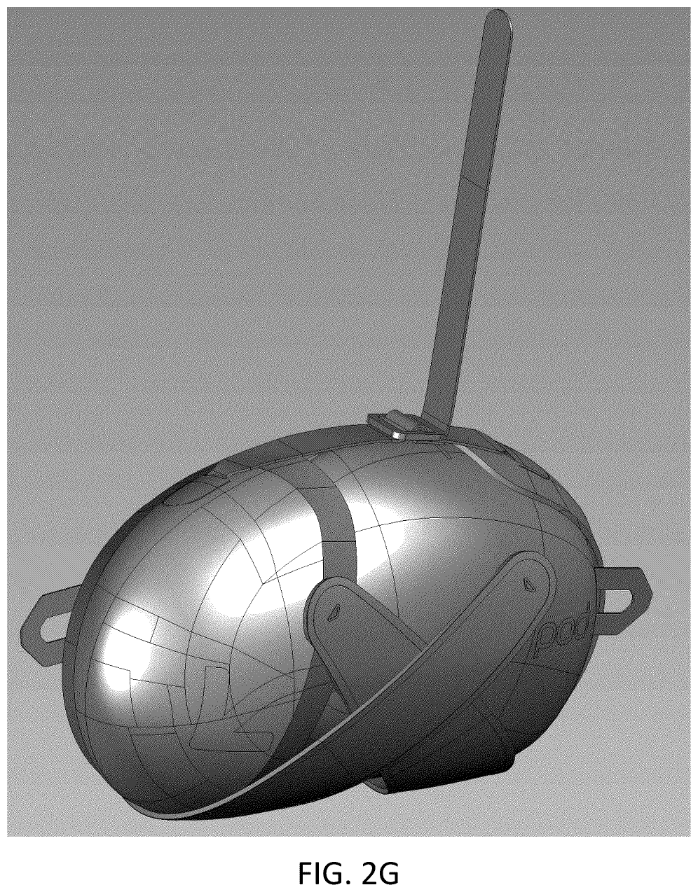

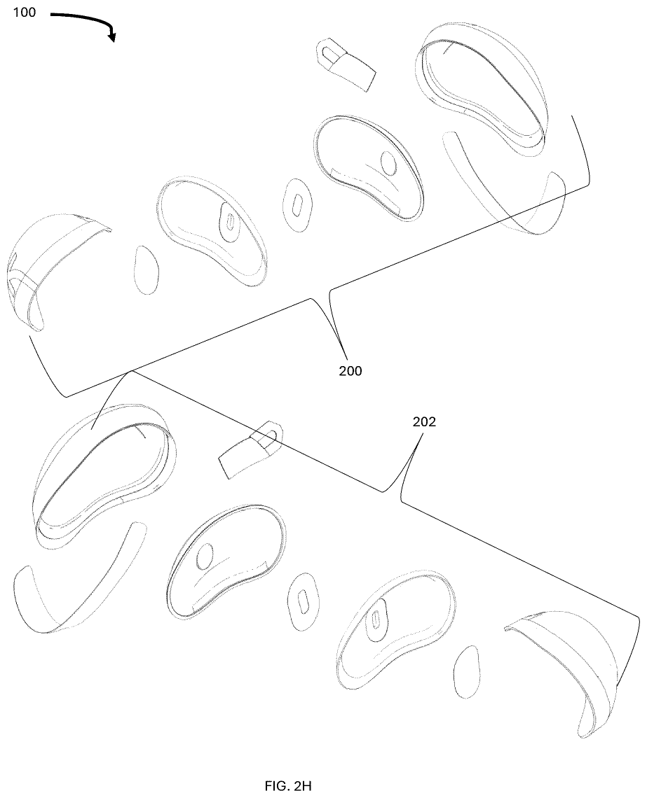

FIGS. 2A-2G illustrate additional views of the organ support system 100 in a closed or secured configuration, in accordance with one or more examples of the present disclosure. FIG. 2H illustrates an exploded view of the organ support system 100 including constituent portions 200, 202 comprising the organ support system 100 in accordance with one or more examples of the present disclosure. The components illustrated in these figures is discussed in detail below in relation to subsequent figures.

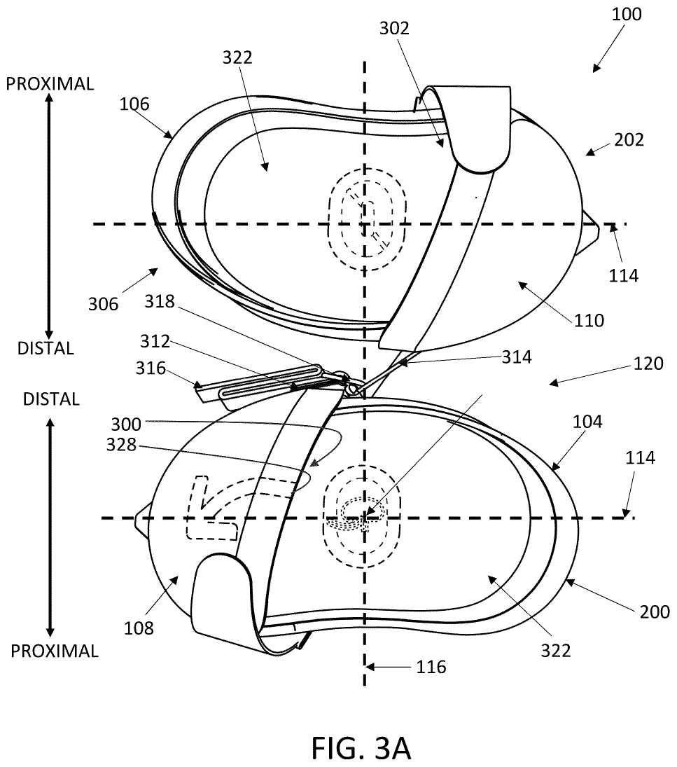

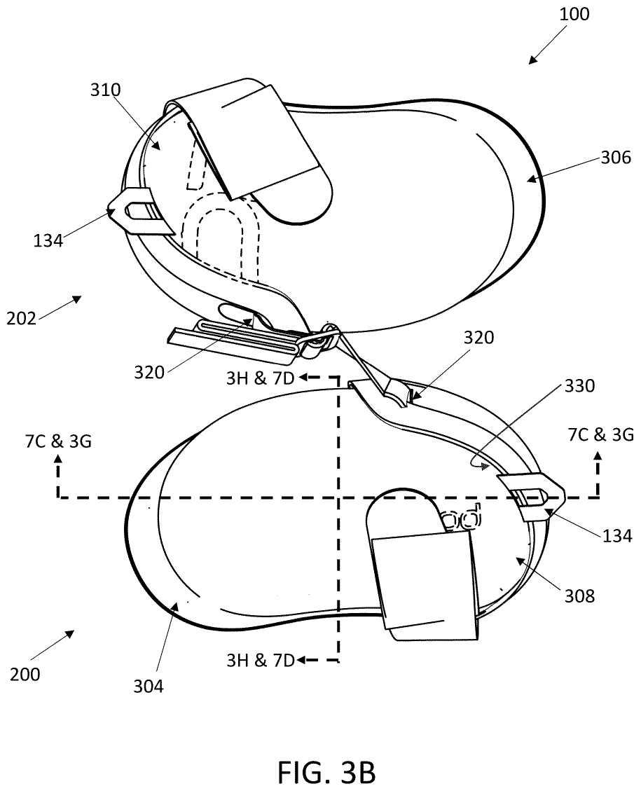

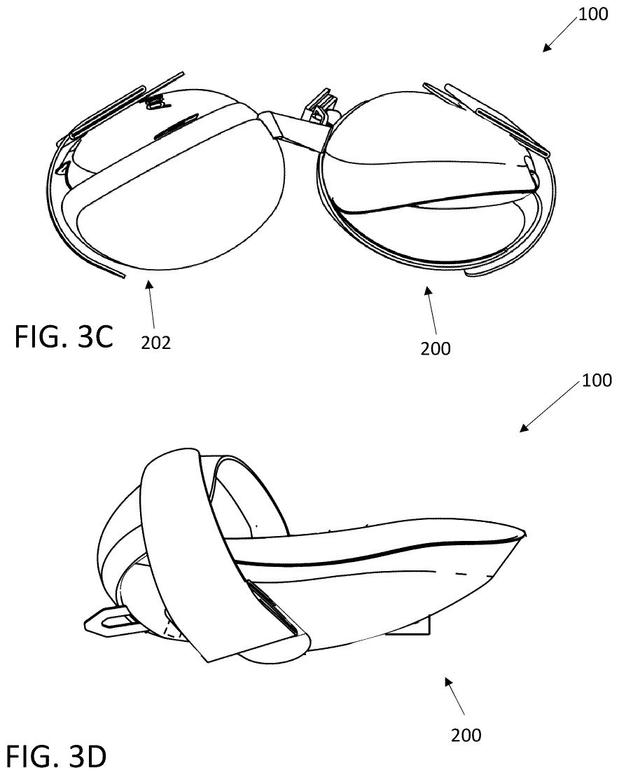

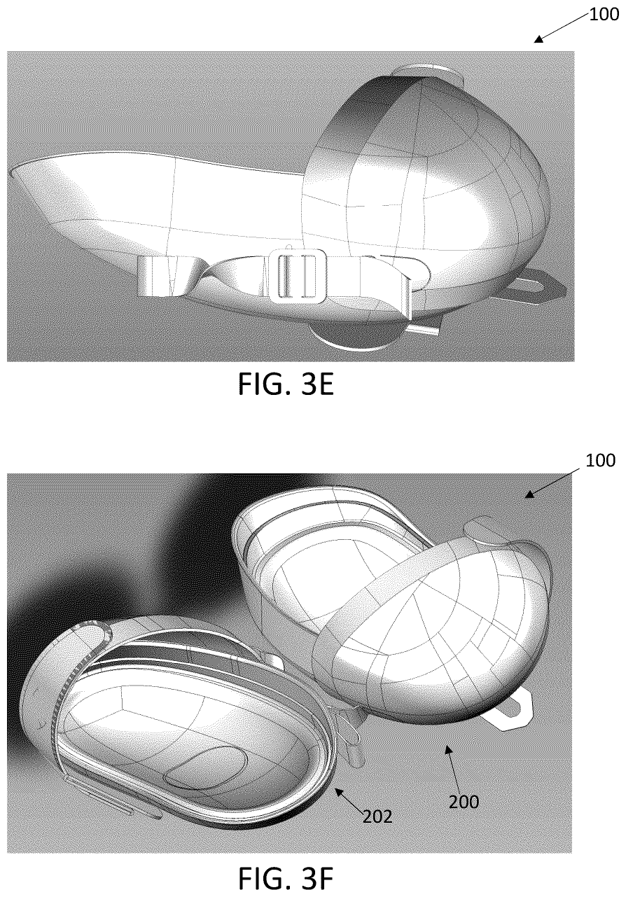

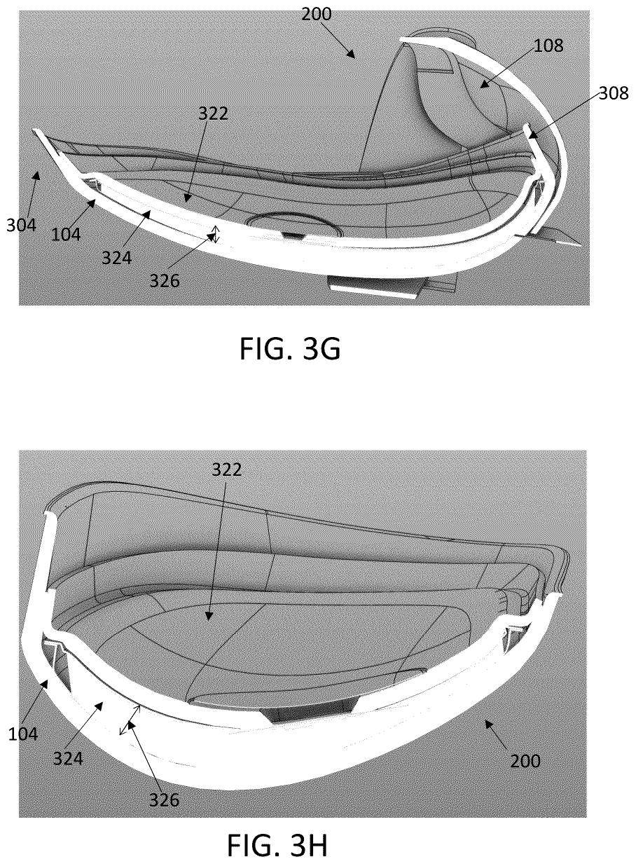

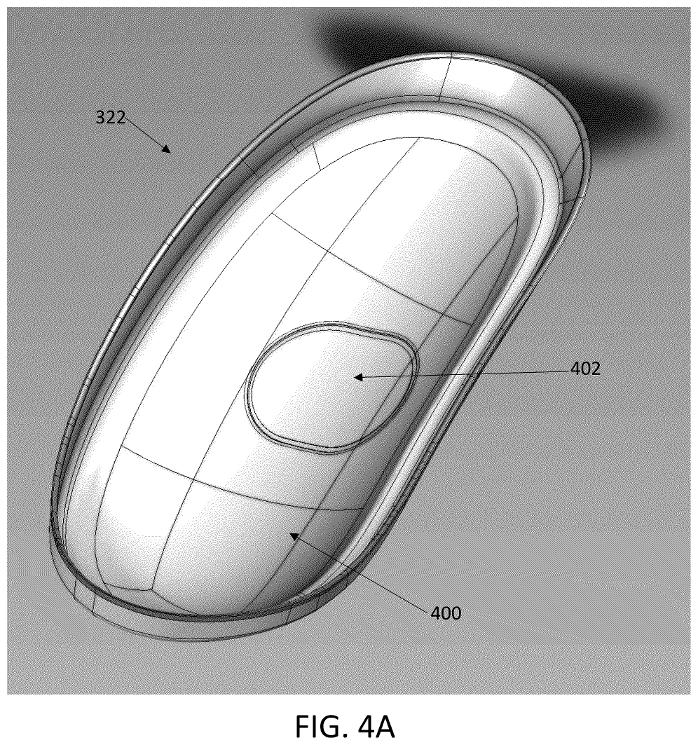

FIGS. 3A-3I illustrate various views of the organ support system 100 in an open configuration, in accordance with one or more examples of the present disclosure. As discussed above, the organ support system 100 can be separated into constituent portions 200, 202. Constituent portions 200, 202 can include a variety of mating geometry, complementary features, surfaced contours, etc. designed to receive corresponding elements of the other constituent portion. FIGS. 3A-3C and FIG. 3F depict the constituent portions 200, 202 side-by-side in an open configuration (e.g., ready to receive an organ). Conversely, and for purposes of illustration, FIGS. 3D-3E and 3G-3H depict a single constituent portion of the organ support system 100.

As shown, the organ support system 100 can include endcap cavities 300, 302. The endcap cavities 300, 302 at least partially define the inner cavity of the organ support system 100 for receiving an organ. In particular examples, the endcap cavities 300, 302 allow for sizing/shape adjustment such that the organ tissue retained within the organ support system 100 maintains as much surface contact as possible with the oblong wall members 104, 106 for continued heat dissipation from the organ. Indeed, as will be discussed below, the margin or amount of overlap between the endcap wall members 108, 110 and the oblong wall members 104, 106 can vary depending on organ size and shape.

The endcap cavity 300 is defined at least in part by the first endcap wall member 108 and the first oblong wall member 104. In these or other examples, the endcap cavity 300 of the first endcap wall member 108 can receive a first end 308 of the first oblong wall member 104 and a second end 306 of the second oblong wall member 106. The first and second ends 308, 304 are located at opposite sides of the longitudinal axis 114 of the oblong housing assembly 102.

Similarly, the endcap cavity 302 is defined at least in part by the second endcap wall member 110 and the second oblong wall member 106. In one or more examples, the endcap cavity 302 of the second endcap wall member 110 can receive a first end 310 of the second oblong wall member 106 and a second end 304 of the first oblong wall member 104. The first and second ends 306, 310 are located at opposite sides of the longitudinal axis 114 of the oblong housing assembly 102.

In these or other examples, a front edge 328 of the first and second endcap wall members 108, 110 can at least partially define the metes and bounds of the endcap cavities 300, 302. In particular examples, the front edge 328 can guide the second end of the opposing constituent portion into the endcap cavity. The front edge 328 (and the endcap cavity as a whole) can also support and help retain the received second end in position.

Additionally or alternatively, the front edge 328 can be asymmetrically shaped or angled non-orthogonally and non-parallel relative to at least one of the longitudinal axis 114 or the first transverse axis 116. In some examples, the front edge 328 is shaped in this way to help define the proximal opening 112 when the constituent portions 200, 202 are joined together. Additionally or alternatively, the angle of the front edge 328 can help facilitate one or more methods of releasing the kidney from the organ support system 100. For example, a distal portion of the front edge 328 can be closer to the first transverse axis 116 than a proximal portion of the front edge 328. Thus, when the constituent portions 200, 202 radially rotate toward the distal direction, the distance of radial translation (or rotation) needed to exit the kidney from the organ support system 100 can be reduced. In particular embodiments, the front edge 328 is angled about 10° to about 60° relative to the first transverse axis 116, about 15° to about 45° relative to the first transverse axis 116, or about 20° to about 30° relative to the first transverse axis 116. In these or other examples, larger angles of the front edge 328 relative to the first transverse axis 116 can provide a larger proximal opening 112.

In these or other examples, a back edge 330 (shown in FIG. 3B) of the first and second endcap wall members 108, 110 can at least partially define the metes and bounds of the endcap cavities 300, 302. Additionally or alternatively, the back edge 330 can be asymmetrically shaped or angled non-orthogonally and non-parallel relative to at least one of the longitudinal axis 114 or the first transverse axis 116. In some examples, the back edge 330 cups (e.g., in a C-Shape fashion) around the outer convex surface of the oblong wall members, particularly the first ends 308, 310 of the respective first oblong wall member 104 and the second oblong wall member 106. In so doing, the back edge 330 can help the first and second endcap wall members 108, 110 serve as a partial moving joint (like a ball-and-socket). In some examples, the back edge 330 can have an adjustable amount of overlap to the oblong wall members to allow adjustment in various dimensions, particularly along the second transverse axis 118 to accommodate greater widths of kidneys.

In some examples, an angle of the back edge 330 is defined relative to a mid-line 204 (shown in FIG. 2C) centrally bifurcating the organ support system 100 along a plane coextensive to the first transverse axis 116 centrally intersecting the proximal opening of the organ support system 100. In these or other examples, the angle of the back edge 330 relative to the mid-line 204 is about 5 degrees to about 30 degrees, about 7 degrees to about 25 degrees, about 10 degrees to about 20 degrees, about 8 degrees to about 15 degrees, or about 15 degrees to about 25 degrees. This angle, in some examples, can define the amount of overlap that the first and second endcap wall members 108, 110 can have with the respective first oblong wall member 104 and the second oblong wall member 106. Additionally or alternatively, the angle of the back edge 330 relative to the mid-line 204 can define a gap 206 (shown in FIG. 2F, albeit occluded by the attachment straps 122, 124) between an endcap wall member and an oblong wall member at a proximal portion of the organ support system 100. In some examples, a larger size of the gap 206 is indicative of less overlap between an endcap wall member and an oblong wall member at the proximal portion of the organ support system 100 (e.g., opening up into the proximal opening 112). Conversely, a smaller size of the gap 206 is indicative of more overlap between an endcap wall member and an oblong wall member. In specific examples, the larger gap size of the gap 206 can facilitate greater ease of releasing an organ retained by the organ support system by allowing the endcap wall member and oblong wall member defining the gap 206 to more easily break apart from each other (e.g., separate in a direction parallel to the second transverse axis 118). In at least one example, the larger gap size of the gap 206 can facilitate greater ease of mating (e.g., slidably joining) the proximal portions of the endcap wall member and oblong wall member.

FIGS. 3A-3G show additional detail of the tether structure 120. As discussed above, the tether structure 120 can couple together various components of the organ support system 100. To do so, the tether structure 120 can include certain arms (e.g., members, supports, tether portions, etc.). For example, tether structure 120 can include a first arm 312, a second arm 314, and a suspension arm 316. The arms can include a variety of connectors (e.g., straps, bands, cinches, belts, cords, harnesses, yokes, etc.). The tether may comprise a solid sheet material or a woven material, and may comprise a ribbon shape, as depicted in FIGS. 3A to 3G, though in other variations, the tether may comprise one or more cords or cable-like shape, and may comprise a polymer such as nylon or EVA plastic. The attachment straps (e.g., the attachable strap members 122, 124) may comprise the same or similar material, in some examples. In other examples, the tether structure 120 may comprise a metal. In particular examples, the tether structure 120 may withstand at least 10 N tensile load In some examples, the tether structure 120 may comprise a layered EVA plastic cord. In some examples, the layered EVA plastic cord can be threaded through eyelets at the superior ends of the shells, opposite the proximal opening 112.

The first arm 312 can connect to at least one of the first endcap wall member 108 or the first oblong wall member 104. The second arm can connect to at least one of the second endcap wall member 110 or the second oblong wall member 106. In one example, the first arm 312 is attached to the first oblong wall member 104, and the second arm 314 is attached to the second oblong wall member 106. In another example, the first arm 312 is additionally attached to the first endcap wall member 108, and the second arm 314 is additionally attached to the second endcap wall member 110. In a certain example, the first arm 312 is fixedly attached to the first oblong wall member 104 and movably attached to the first endcap wall member 108. Similarly, the second arm 314 can be fixedly attached to the second oblong wall member 106 and movably attached to the second endcap wall member 110. By allowing respective movement of the endcap wall members 108, 110 relative to the first arm 312 and the second arm 314, the endcap wall members 108, 110 can take up slack in (e.g., slide along) the first and second arms 312, 314 to allow the endcap wall members to accommodate different kidney sizes and shapes. Additionally or alternatively, the endcap wall members 108, 110 can take up slack in (e.g., slide along) the first and second arms 312, 314 to flexibly allow the endcap cavities 300, 302 to radially rotating during kidney removal from the organ support system 100 (e.g., such that the endcap wall members 108, 110 can hingedly move relative to the respective first and second oblong wall members 104, 106). In certain examples, the endcap wall members 108, 110 can respectively rotate about 10 degrees to about 180 degrees relative to the first and second oblong wall members 104, 106, about 60 degrees to about 150 degrees, about 90 degrees to about 120 degrees, or about 100 degrees to about 140 degrees. In some examples, the foregoing degree of angular freedom can be achieved along various planes and/or in various directions (e.g., in a distal direction parallel to the mid-line 204 for releasing the retained organ, or in a proximal direction parallel to the mid-line 204 for securing an organ). In one or more examples, the angular degree of freedom just described can help facilitate a more convenient, ergonomic release and mating of the corresponding endcap wall members and the oblong wall members.

In some examples, a location of the connection for the first arm 312 and the second arm 314 to the endcap wall members 108, 110 and/or the first and second oblong wall members 104, 106 can help define the above angular degree of rotational freedom (e.g., for a desired exit clearance during organ release or flexibility to splay or spread apart when the organ is released). In particular examples, the location of the connection for the first arm 312 and the second arm 314 are positioned at a distal portion of organ support system 100 such that the proximal portion of the organ support system 100 can release the retained organ more easily and readily. In particular examples, a location of the connection for the first arm 312 and the second arm 314 is positioned at least 60 percent to about 95 percent of the distal most portion of the organ support system 100, about 65 percent to about 75 percent of the distal most portion of the organ support system 100, or about 70 percent of distal most portion of the organ support system. Similarly, a location of the connection for the first arm 312 and the second arm 314 can be positioned laterally (e.g., left or right) of the first transverse axis 116 by a certain amount (e.g., between about 2 percent to about 30 percent of the longitudinal span of the organ support system 100 measured along the longitudinal axis 114, about 5 percent to about 20 percent, about 10 percent to about 15 percent, or about 15 percent to about 25 percent). Additionally, a location of the connection for the first arm 312 and the second arm 314 can be positioned forward or backwards (e.g., closer to the back edge 330 or closer to the front edge 330 by a certain amount, such as between about 2 percent to about 30 percent of the width of the organ support system 100 measured out from the mid-line 204 along the second transverse axis 118, about 5 percent to about 20 percent, about 10 percent to 15 percent, or about 7 percent to about 12 percent. Accordingly, the location of the connection for the first arm 312 and the second arm 314 to the endcap wall members 108, 110 and/or the first and second oblong wall members 104, 106 can be tuned and optimized in at least one degree of freedom, at least two degrees of freedom, or some cases three degrees of freedom. In certain examples, this multi-dimensional tuning of the connection location for the first arm 312 and the second arm 314 to the endcap wall members 108, 110 and/or the first and second oblong wall members 104, 106 can help achieve a desired ease of movement therebetween, a desired fit of different possible organ sizes, an ease of release and/or joining of walls, a spreadability (or splayableness accommodating clearance for organ release), etc.

In other variations, the endcap wall members may be fixedly attached to the tether arms, with a fixed length of tether between the endcap wall members and its corresponding oblong wall member. Length of the connection between the shell and buckle is 55 mm. Length of lanyard extending from buckle to end is 10-30 cm. The lanyard length is user-adjustable or selectable between about 100 mm and about 300 mm, with a preferred operating band of 150-220 mm. The lanyard length is long enough for gravity-assisted radial opening (Δθ≈30−50°) yet short enough to avoid externalizing the lanyard through the access port during insertion.

In at least one alternative example, the first and second arms 312, 314 do not respectively couple the endcap wall members 108, 110 and the first and second oblong wall members 104, 106. Rather, the endcap wall members 108, 110 and the first and second oblong wall members 104, 106 can be coupled in other ways instead (and still provide the same or similar relative freedom of movement therebetween, albeit a reduced freedom of movement or range of motion in some embodiments). In certain examples, the endcap wall members 108, 110 are respectively coupled to the first and second oblong wall members 104, 106 in a removable or detachable manner. In other examples, the endcap wall members 108, 110 are respectively coupled to the first and second oblong wall members 104, 106 in a permanent, non-removable manner (e.g., inseparable without destructive, irreversible disassembly). In specific examples, the endcap wall members 108, 110 and the first and second oblong wall members 104, 106 can be coupled via a hinge coupling, swivel coupling, button coupling, snap coupling, interlocking coupling, clasp coupling, pin (rivet or other fastener coupling), weld coupling, taped coupling, flexible coupling, spring coupling, bonded coupling, adhesive coupling, stitched coupling, etc.

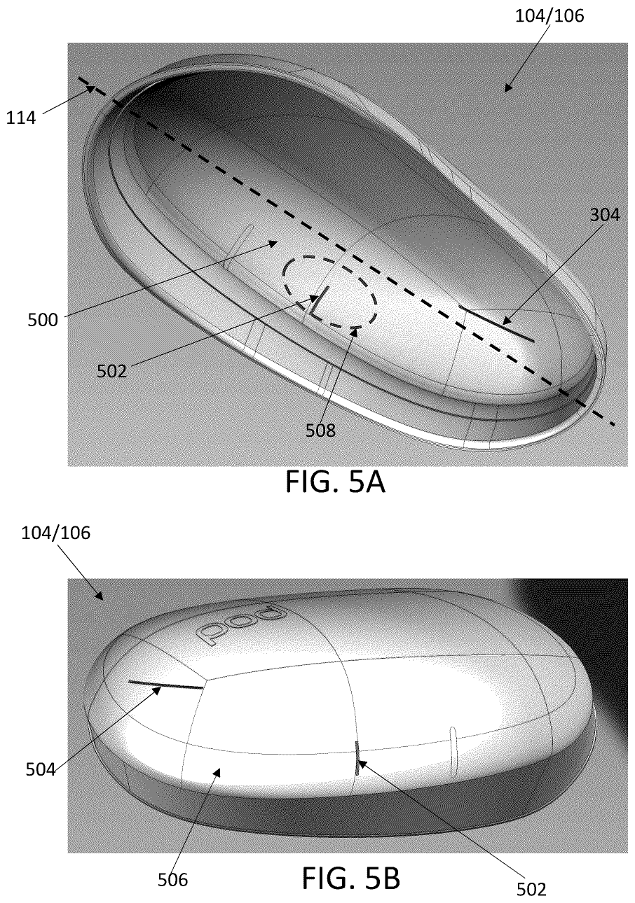

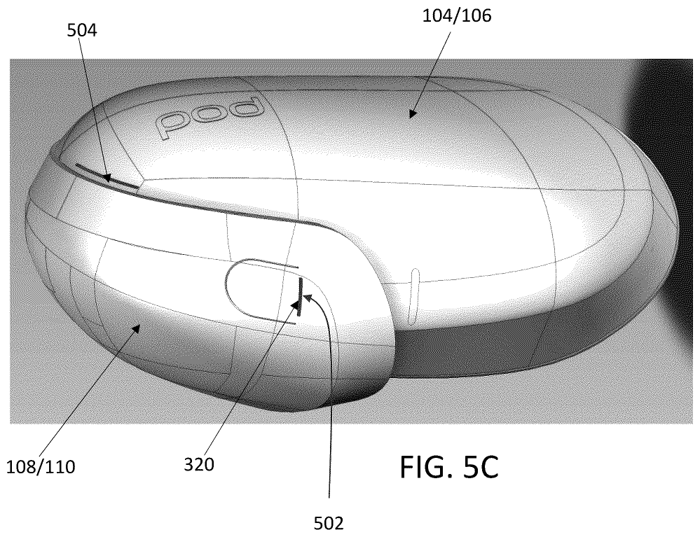

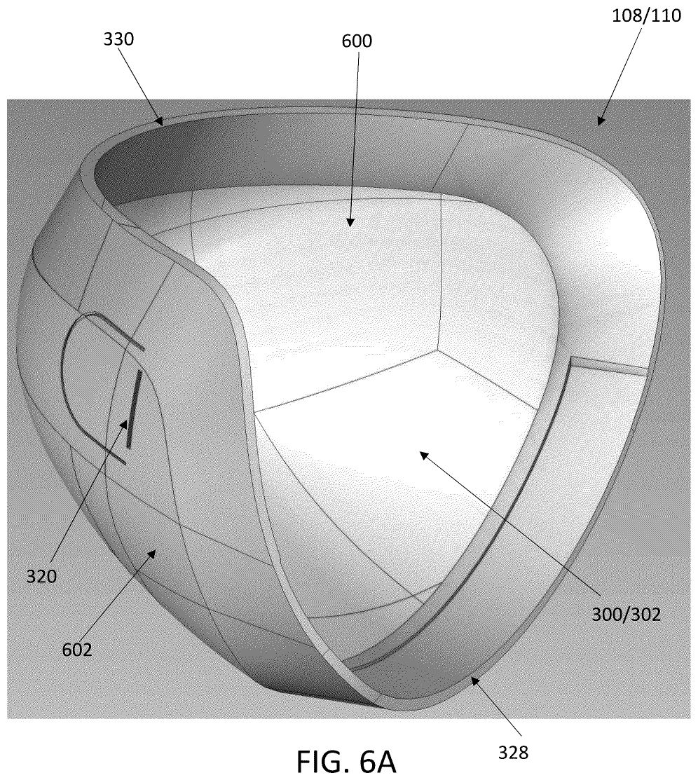

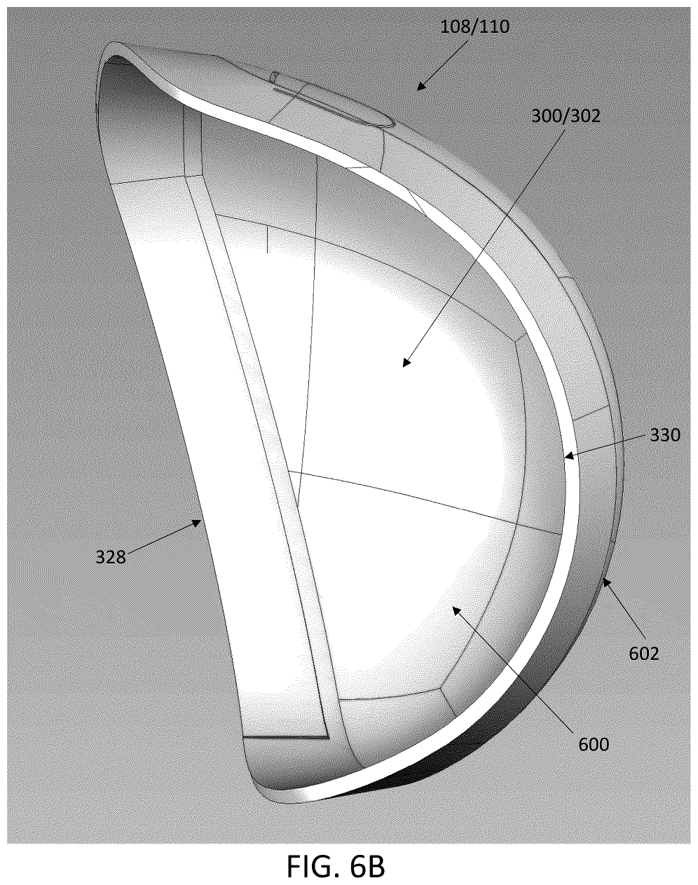

As discussed above, attachment sites for the first and second arms 312, 314 can be positioned in various locations. In some examples, the attachment sites for the first and second arms 312, 314 are located on a distal portion of the organ support system 100. The attachment site can be an external and viewable from external view. Conversely, the attachment site can be internal and at least partially obscured from external view. In at least one example, arm openings 320 are defined by one or more of the plurality of outer wall structures, wherein the arm openings 320 are sized and shaped to receive the first and second arms 312, 314. The first and second arms 312, 314 can slidably pass through the arm openings 320. In this particular exemplary embodiment, the arm openings 320 comprises a slot shape corresponding to the ribbon shape of the arms 312, 314, but in other variations, the openings may be circular, ovular or polygonal. Internal to the arm openings 320, end portions of the first and second arms 312, 314 can be secured in place (e.g., against one or more surfaces of the endcap wall members or the oblong wall members). As shown in FIG. 3B, the arm openings 320 are defined by at least the first and second endcap wall members 108, 110. In some further variations, the configuration of the arm opening may vary depending on the desired sliding resistance between the arms 312, 314 and the openings 320. In some other variations, the arms 312, 314 may be fixedly attached via adhesive or suture to the endcap wall members at a location along its length so as to limit the amount or range of displacement of the endcap wall member from the oblong wall member or hub. In FIGS. 5C, 6A, 6B, for example, a U-shape suture has been used to attach the arm to the endcap wall member, to limit separation of the endcap wall member from the oblong wall member.

As mentioned, the tether structure 120 can include suspension arm 316. The suspension arm 316 can be sized and shaped for suspending the organ support system 100 in the air (e.g., above a surgical site for organ transplantation). The suspension arm 316 can thus include a durable material (e.g., rated to hold a certain weight or execute a certain number of suspension cycles). In one or more examples, the suspension arm 316 can include a material having a predetermined elasticity, stretch, etc. In these or other examples, the suspension arm 316 can be raised or held in place via robotic operation (e.g., robotic grippers or hooks) and/or human technician. Although depicted as a strap, the suspension arm 316 can include a rigid member (e.g., metal beam with an eyelet configured for a robotic gripper). A rigid member can, in some examples, be advantageous to prevent undesired sway or movement of the organ support system 100, particularly during anastomosis or other procedure portion. Those of ordinary skill in the art, having the benefit of this disclosure, will appreciate that the suspension arm 316 is not required to be suspended. In some examples, the organ support system 100 is laid adjacent to the surgical site, and the anastomosis is performed while the organ support system is unsuspended (e.g., laid on its side) and the suspension arm 316 is untensioned. In some cases, albeit the suspension arm 316 may be untensioned, the suspension arm 316 can still be secured to a robotic arm to ensure the organ support system 100 maintains a position during the anastomosis procedure.

Further shown in the figures, the tether structure 120 can include a hub 318. The first and second arms 312, 314 and the suspension arm 316 can each connect to or extend from the hub 318. The hub 318 can include a connection feature, such as a slider, buckle, clip, ratchet, cam, and the like. In one or more examples, the hub 318 can facilitate adjustment of the first and second arms 312, 314 and the suspension arm 316. In at least one example, the hub 318 can facilitate complete detachment of the first and second arms 312, 314 and the suspension arm 316.

Additionally shown, the organ support system 100 can include an inner contact structure 322. The inner contact structure 322 is configured to make direct, intimate contact with an organ (e.g., the kidney 126). In some examples, the inner contact structure 322 can be an insulative layer, a freeze protection layer, a spacer layer, a temperature control layer, etc. In particular examples, the inner contact structure 322 can be positioned between an oblong wall member and a cooling structure (e.g., a cooling structure 324 discussed below). In particular examples, the inner contact structure 322 is sized and shaped to substantially or entirely overlap a cooling structure. In these or other examples, the inner contact structure 322 can help prevent freezing of organ cells that could otherwise occur if a cooling structure had direct contact with the organ. In some examples, the inner contact structure 322 include a thin, waterproof, biocompatible material (e.g., closed cell foam, silicone, etc.).

In one or more examples, the inner contact structure 322 can fit complementary to various elements. As used herein, the terms “complementary” or “complementary surfaces” should refer to surfaces that fit together, match, continuously (or substantially continuously) abut, follow surface geometry, and/or mimic surface contours. Thus, as shown in FIGS. 3G-3H, the first oblong wall member 104 (and the second oblong wall member 106) can include an inner contact structure 322. The inner contact structure 322 can include an outer convex surface complementary to the inner concave surface of the cooling structure 324. The concave surface of the inner contact structure 322, as just mentioned, is configured to directly contact an organ located in the inner cavity of the organ support system 100.

As mentioned above, the organ support system 100 can include a cooling structure 324. In one or more examples, the first and second oblong wall members 104, 106 can each comprise a cooling structure 324. Cooling structure 324 can include one or more elements that can absorb or dissipate heat from the retained organ within the organ support system 100. One example of the cooling structure 324 can include a layer that includes a phase-change material (e.g., that can change from solid to liquid form throughout the transplantation procedure). The phase-change material can include saline, water, gel (e.g., biocompatible phase-change gels, such as 1-Decanol (Decyl alcohol), n-tetradecane (n-TD), and the like), eutectic mixture (e.g., a water-tetradecane blend), etc. In some examples, the phase-change material can be designed to maintain a kidney temperature of about 1 degree Celsius to about 7 degrees Celsius for a predetermined duration (e.g., about 30 minutes to about 90 minutes, about 45 minutes to about 70 minutes, or about 60 minutes). In particular examples, the cooling structure 324 is expressly devoid of coolant tubes or external cooling feeds into the organ support system 100.

Like other elements of the organ support system 100, the cooling structure 324 can fit complementary to other surfaces. For example, an outer convex surface of the cooling structure 324 can fit complementary to the inner concave surface of the corresponding oblong wall member. In addition, an inner concave surface of the cooling structure 324 can fit complementary to the outer convex surface of the inner contact structure 322.

One or more elements of the organ support system 100 can include a variable thickness along one or more axes. In specific implementations, the cooling structure 324 can include a thickness 326. As shown in the longitudinal cross-section of FIG. 3G and the first transverse axis cross-section of FIG. 3H, the thickness 326 of the cooling structure 324 can vary across the organ support system 100. In particular examples, the thickness 326 of the cooling structure 324 is greatest at a central region of the organ support system 100. In such examples, the thickness 326 of the cooling structure 324 can gradually decrease or taper toward one or more perimeter edges. By thinning the thickness 326 toward the perimeter edges, particularly the proximal edges, the organ support system 100 can advantageously maintain a smaller footprint immediately adjacent to the surgical workspace around the proximal opening 112 (e.g., between the proximal opening 112 and the patient). Additionally, by maintaining greater thickness in the center and/or distal regions, the cooling structure 324 can help maintain a desired temperature of the organ tissue. In specific implementations, the thickness 326 can vary in a range of about 20 percent to about 35 percent across the longitudinal and/or first transverse axes. In at least one embodiment, the thickness 326 measures about 0.5 mm to about 5 mm, about 1 mm to about 3 mm, or about 2 mm toward the proximal edge of the cooling structure 324 (adjacent to the proximal opening 112). In comparison, the thickness 326 can measure about 3 mm to about 12 mm, about 4 mm to about 8 mm, or about 6 mm in the central and/or more distal regions of the cooling structure 324.

Any of the features, components, and/or parts, including the arrangements and configurations thereof shown in FIGS. 3A-3I can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 3A-3I.

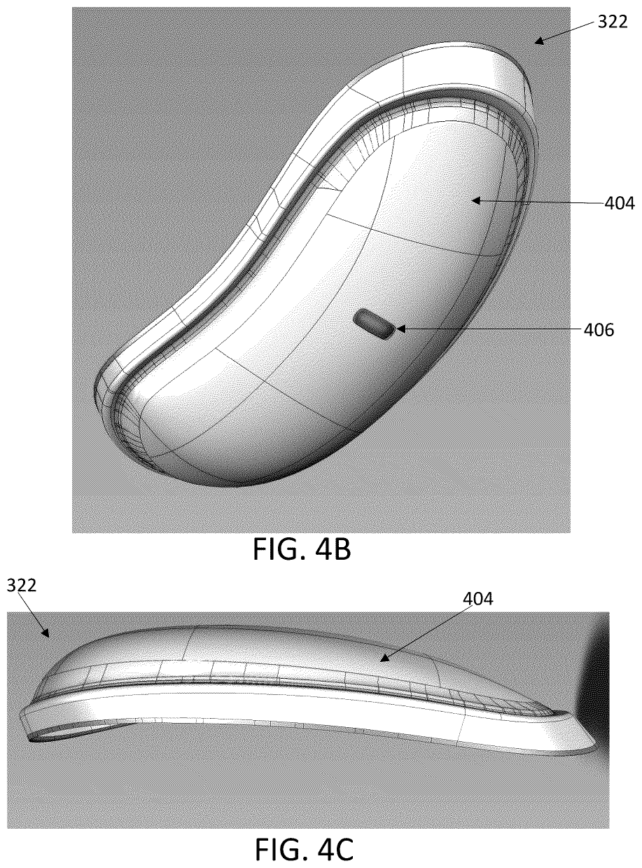

FIGS. 4A-4C illustrate the inner contact structure 322 in accordance with one or more examples of the present disclosure. As shown, FIG. 4A depicts a perspective view of the inner contact structure 322 as including a concave surface 400 configured to contact an organ. FIG. 4A additionally depicts an indicator 402 (e.g., a temperature indicator, orientation indicator, etc.).

FIG. 4B illustrates a perspective view of the inner contact structure 322 including a convex surface 404. The convex surface 404 can be positionable against a concave surface of the cooling structure 324. In some examples, the convex surface 404 can define a temperature window 406 (e.g., a through hole or thermally conductive passageway) sized and shaped to receive to allow the indicator 402 to detect or gauge the temperature of the cooling structure 324 (e.g., for indicating thermal readiness of the cooling structure 324). Additionally or alternatively, the temperature window 406 can be sized and shaped to receive a temperature sensor communicatively coupled to the indicator 402.

FIG. 4C illustrates a top (distal) plan view of the inner contact structure 322 in accordance with one or more examples of the present disclosure.

Any of the features, components, and/or parts, including the arrangements and configurations thereof shown in FIGS. 4A-4C can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 4A-4C.

FIGS. 5A-5C illustrate one of the oblong wall members 104, 106 in accordance with one or more examples of the present disclosure. As shown, FIG. 5A illustrates the oblong wall member 104/106 including a concave surface 500 at least partially defining the inner cavity sized and shaped to receive the cooling structure 324, the inner contact structure 322, and at least part of an organ. The concave surface 500 defines an arm opening 502 and a handle opening 504. The arm opening 502 and the handle opening 504 extend through to a convex surface 506 (shown in FIG. 5B). In one or more examples, the arm opening 502 is sized and positioned correspond to the arm opening 320 in the endcap wall member 108/110. Thus, in some embodiments, the first and second arms 312, 314 can pass through the endcap wall members 108, 110 and the oblong wall members 104, 106. In these or other examples, an end portion of the first and second arms 312, 314 (discussed and shown in relation to FIG. 3A for example) can be retained at an attachment site 508 against the concave surface 500. In one or more examples, the attachment site 508 is spaced away from one or both pole ends of the longitudinal axis 114 of the oblong wall member. In certain examples, this positioning of the attachment site 508 can serve as a pivot point (e.g., at a distal oblong wall portion) for the corresponding arm of the tether structure 120 to induce a radial rotation when the organ support system 100 is moved/adjusted to the released configuration.

In other examples, the handle opening 504 is sized and shaped to receive the handle 134 discussed above. In some examples, the handle 134 can be anchored or otherwise coupled to the concave surface 500.

Any of the features, components, and/or parts, including the arrangements and configurations thereof shown in FIGS. 5A-5C can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 5A-5C.

FIGS. 6A-6B illustrate perspective views of one of the endcap wall members 108, 110 in accordance with one or more examples of the present disclosure. These views depict one of the endcap cavities 300, 302 (e.g., as defined by the front edge 328 and the back edge 330 discussed above). The endcap cavities 300, 302 are defined at least in part by an inner concave surface 600 opposite an outer convex surface 602.

Any of the features, components, and/or parts, including the arrangements and configurations thereof shown in FIGS. 6A-6B can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 6A-6B.

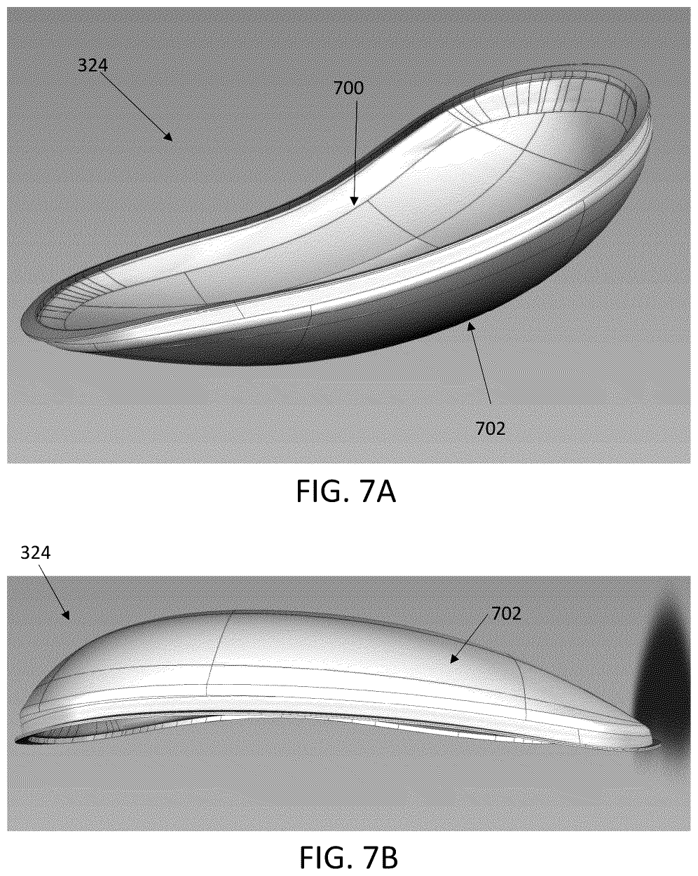

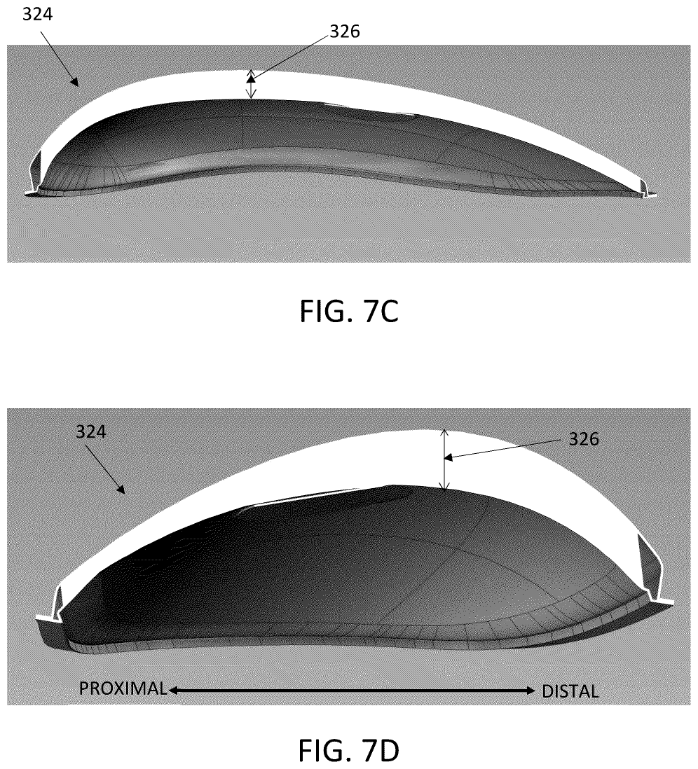

FIGS. 7A-7D illustrate the cooling structure 324 in accordance with one or more examples of the present disclosure. FIGS. 7A-7B illustrate perspective views of the cooling structure 324 including a concave surface 700 sized and shaped to complement the convex surface 404 of the inner contact structure 322, and a convex surface 702 sized and shaped to complement the concave surface 500 of the oblong wall member. In the longitudinal cross-section of FIG. 7C and the first transverse axis cross-section of FIG. 7D, the thickness 326 of the cooling structure 324 can vary in certain dimensions. In particular examples, the thickness 326 can decrease in the proximal direction, as discussed above.

Any of the features, components, and/or parts, including the arrangements and configurations thereof shown in FIGS. 7A-7D can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 7A-7D.

FIGS. 8A-8D illustrate an example method flow of a series of acts (or steps) of retaining an organ to cool within another example implementation of an organ support system, in accordance with one or more examples of the present disclosure. While FIGS. 8A-8D illustrate acts (or steps) according to one embodiment, alternative embodiments may omit, add to, reorder, and/or modify any of the acts shown in FIGS. 8A-8D. The acts of FIGS. 8A-8D can be performed as part of a method. Alternatively, a non-transitory computer-readable medium can comprise instructions that, when executed by one or more processors, cause a computing device (or a computer component, such as a processor, implemented on or in communication with a robotic apparatus) to perform the acts of FIGS. 8A-8D. In some embodiments, a system can perform the acts of FIGS. 8A-8D.

As shown in FIG. 8A, a step 800a can include providing an organ support system 802 with constituent portions 804, 806. The organ support system 802 can be the same as or similar to the organ support system 100 discussed above. In particular examples, however, the constituent portions 804, 806 of the organ support system 802 each comprise a single piece unit including a combined oblong wall member portion and an endcap wall member portion integrally formed together.

In FIG. 8B, a step 800b can include inserting the kidney 126 into the constituent portion 806. Kidney 126 can be oriented with hilar portions extending in a proximal direction and a ureter extending toward a ureter pole of the organ support system 802.

In FIG. 8C, a step 800c can include bringing the constituent portions 804, 806 together, thus covering the kidney 126 and closing the organ support system 802. In addition, the step 800c can include cinching or tightening a tether structure 808 (e.g., to remove slack in the tether structure 808 and help maintain the constituent portions 804, 806 together).

In FIG. 8D, a step 800d can include securing attachable strap members 810 provide a closed, secured configuration of the organ support system 802. FIG. 8E illustrates a top (distal) plan view of the organ support system 802 in the closed, secured configuration. FIG. 8F illustrates a close-up view of an endcap wall member portion of the organ support system 802 in the closed, secured configuration. Specifically, FIG. 8F shows an endcap wall member portion of the organ support system 802 including a slot 812. In one or more examples, the slot 812 can allow the organ support system 802 to expand or contract for suitably fitting periods shapes and sizes of organs. In some examples, the attachable strap members 810 can maintain a spacing of the slot 812, and thus maintaining a fit of the organ support system 802 about the kidney 126.

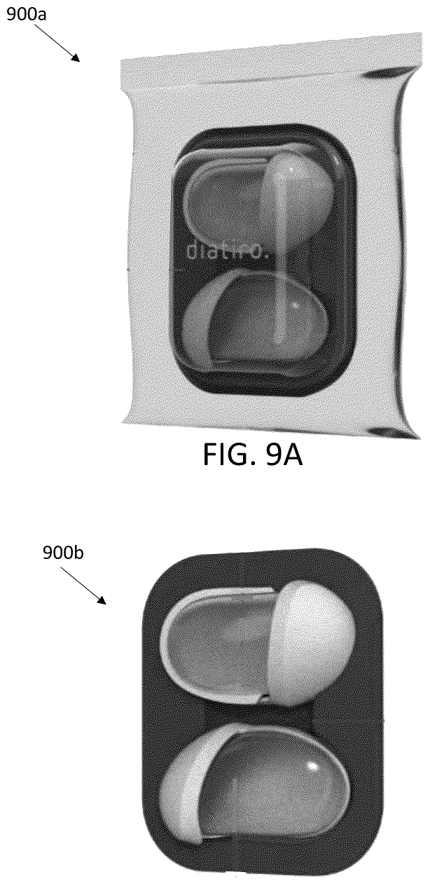

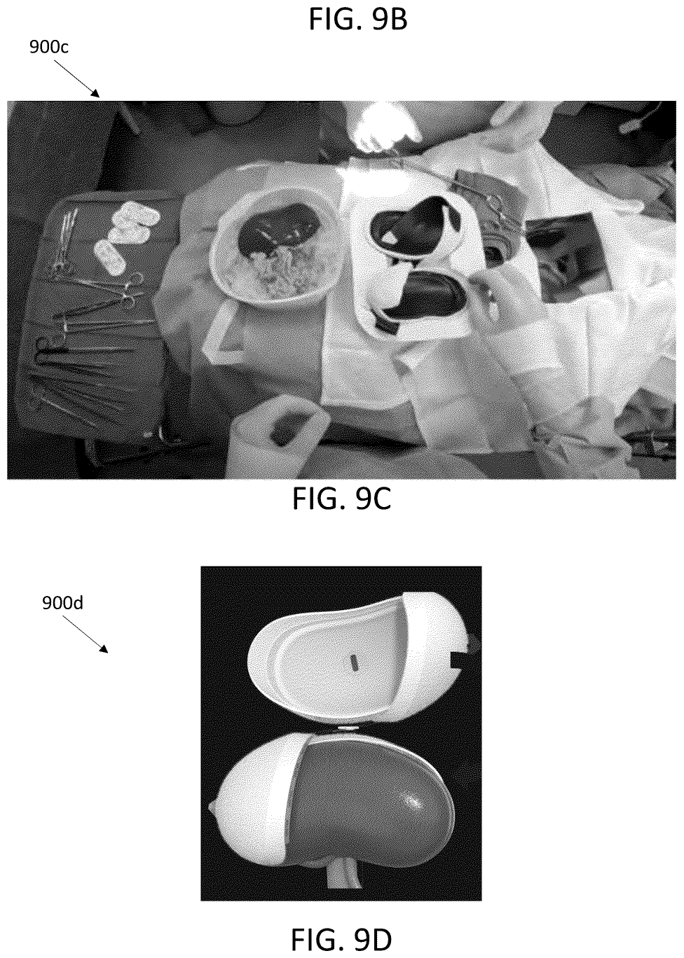

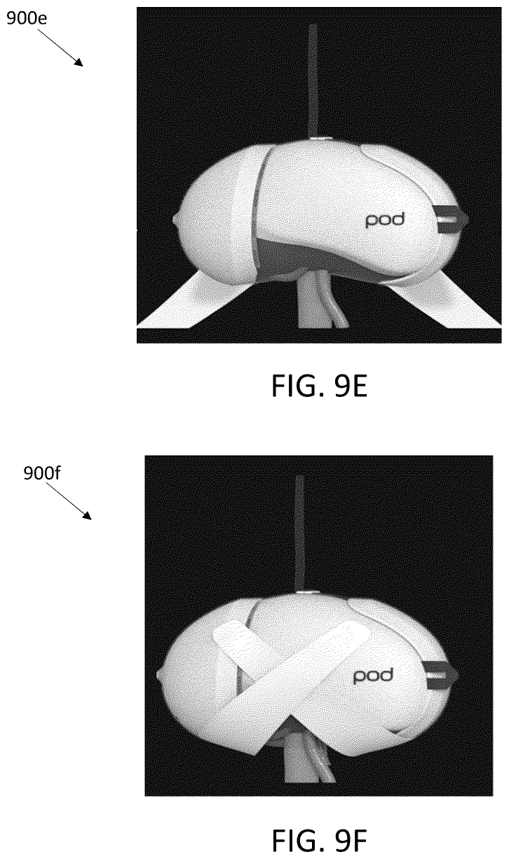

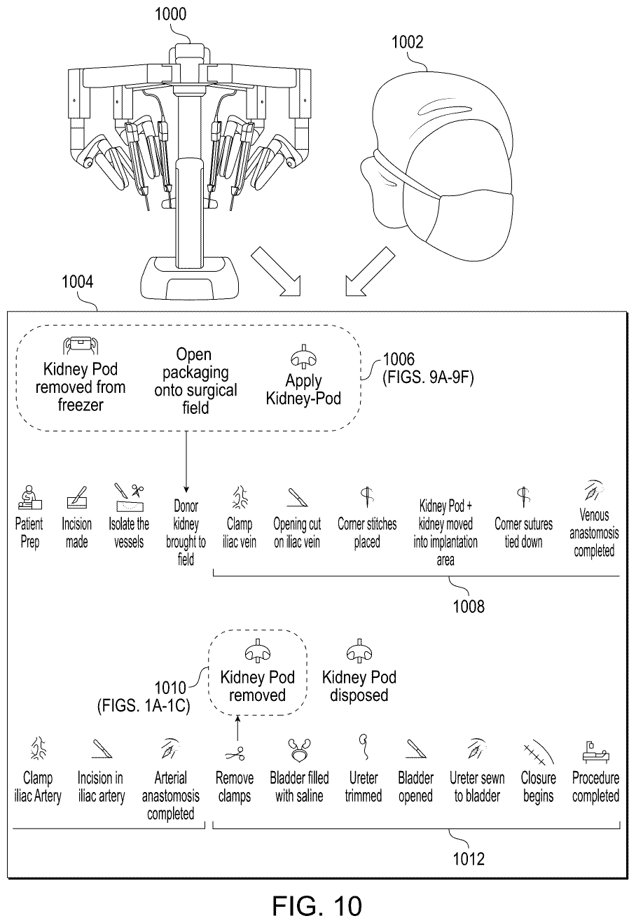

FIGS. 9A-9F illustrate another example method flow of retaining an organ to cool within an organ support system, in accordance with one or more examples of the present disclosure. While FIGS. 9A-9F illustrate acts (or steps) according to one embodiment, alternative embodiments may omit, add to, reorder, and/or modify any of the acts shown in FIGS. 9A-9F. The acts of FIGS. 9A-9F can be performed as part of a method. Alternatively, a non-transitory computer-readable medium can comprise instructions that, when executed by one or more processors, cause a computing device (or a computer component, such as a processor, implemented on or in communication with a robotic apparatus) to perform the acts of FIGS. 9A-9F. In some embodiments, a system can perform the acts of FIGS. 9A-9F.

As shown in FIG. 9A, a step 900a can include providing a package or packaging system including an organ support system of the present disclosure. The packaging system can include a tray. In some examples, the package can include a sterile barrier pouch enclosing the tray to ensure the tray and everything within the tray remain sterile for surgery. The tray can be made of various different materials and it can be formed in various different ways using different methods. In particular examples, the tray can be form molded. In other examples, the tray can be thermoformed. In some examples, the tray can comprise high-density polyethylene. In some examples, the tray can comprise polyethylene terephthalate glycol (PETG). In some examples the tray can be insulative or can include insulative tray walls configured to minimize heat influx from ambient operating room temperatures or other ambient external air temperatures. In particular examples, the tray can include a first compartment sized to receive the organ support system's housing. In some examples, the first compartment can be shaped similarly to the organ support system. In these examples, the first compartment shaped similarly to the organ support system can enable intimate thermal contact along the lower shell surface. In some examples, the tray can further include a second compartment. The second compartment can be sized to receive a phase-change material insert. In some examples, the first compartment can include a thermally conductive film. In this example, the thermally conductive film can contact an underside of the housing to insulate the first compartment from the exterior surroundings. In some examples, the package further comprises a closure strap configured to secure the package.

In some examples, the tray can include a removable phase-change material insert which can be positioned in at least one of the compartments, such as the first compartment or the second compartment. In some examples, the phase-change material insert can be sealed. In particular examples, the phase-change material insert can be sealed in multilayer film. In particular examples, the phase-change material insert can be sealed in conductive film. In some examples, the phase-change material insert can include various different materials with various different melting points. In particular examples, the removable phase-change material insert can include an eutectic water-tetradecane blend. In this example, the eutectic water-tetradecane blend can have a melting point between 0° C. and 4° C. In some examples, the phase-change material insert can include tabs enabling sterile removal post-cooling. This step can be performed immediately before implantation when the tray is removed from the freezer and transferred into the sterile field. In some examples, the tab can be a pull-tab. In particular examples, once the phase-change material insert is removed from the housing cavity, it may be discarded. In some examples, the insert volume of the phase-change material insert can be sized to absorb at least 30 kJ. In other examples, the insert volume of the phase-change material insert can be sized to absorb at least 50 kJ. In particular examples, the removable phase-change material insert can be formed to mate with the shape of the second compartment, making thermal contact with the organ support system's housing. In particular examples, the insert can be removable post-cooling.

The removable phase-change material insert can be configured to transfer heat from the housing when the housing rests in the first compartment. In particular examples, the insert can contain a material with a melt temperature between −5° C. and 15° C. In other examples, the insert can contain a material with a melt temperature between 0° C. and 10° C. In particular examples, the insert can contain a material with a melt temperature between 3° C. and 5° C. In one or more examples, the organ-preservation housing can be placed in thermal contact with the phase-change material insert within the tray. In particular examples, the phase-change material insert can be configured to contact the underside of the housing shell via the conductive film. Additionally or alternatively, the package can be frozen (e.g., until retrieved at step 900a) either due to the phase-change material insert or a separate cooling device.

In some examples, the tray can be pre-loaded with the organ support housing and a frozen phase-change material insert, stored in a freezer. In particular examples, the tray can be stored at a temperature cold enough to freeze the phase-change material insert and the package to the predetermined temperature. In specific examples, the phase-change material insert can be stored in a freezer at approximately −20° C. In this example, while in the freezer or while exposed to freezing temperatures, the phase-change material insert solidifies. In some examples, the package is configured to be left in the freezer for a predetermined amount of time ensuring that the package reaches the predetermined temperature. This time can vary based on the predetermined temperature, the size of the package, the temperature of the freezer, and other related conditions. In particular examples, the package is recommended to be left in the freezer for 24 hours or longer to charge the thermal batteries completely. Moreover, in some examples, the package is recommended to be stored horizontally. In other examples, a 45 degree tilt in any direction is acceptable. In some examples, a “fully charged” thermal battery, meaning the thermal battery has reached its predetermined temperature, can maintain the predetermined temperature (around 4° C.) of the organ support housing for at least 60 minutes (starting at the time the package is removed from the freezer) at ambient operation room (OR) temperatures of approximately 22-25° C.

After the organ-preservation housing is placed in thermal contact with the phase-change material insert within the tray, a step 900b can include leaving the housing in contact with phase-change material insert within the tray for a dwell time. In particular examples, the dwell time can be a certain amount of time, such as between 2 and 20 minutes. In other examples, the dwell time can be between 5 and 10 minutes. In some examples, once a sufficient amount of dwell time has passed a temperature indicator included with the organ-preservation housing or the package. In particular examples, the temperature indicator can vary in color to indicate when a predetermined temperature is reached. In particular examples, the temperature indicator can include a thermal-battery indicator. For example, the thermal-battery indicator can be one color, such as red, until the predetermined temperature is reached at which time the organ-preservation housing can change colors, such as to blue. In some examples, the predetermined temperature can be any temperature. In particular examples, the phase-change material can include an embedded dye to confirm the temperature of the phase-change material. Similarly, the organ-preservation housing can include an embedded dye to confirm the temperature of the organ-preservation housing. In particular examples, the predetermined temperature can be 15° C. or lower. In other examples, the predetermined temperature can be 10° C. or lower. In still other examples, the predetermined temperature can be 6° C. or lower. An additional step of removing the insert from the tray after step 900b can be included in the method of preparing an organ-preservation housing. In FIG. 9B, a user can remove the organ support system from the package. In some examples, a surgical technician can apply pressure or a compressive force to both terminal ends of the shell halves, gently “cracking” the shell half to increase flexibility and to improve the fit of the shell half around the allograft when the organ is placed in the shell halves.

In FIG. 9C, a step 900c can include providing an organ (e.g., in a cooled condition, transport condition, etc.) ready for transplantation into a patient. The organ can be positioned in proximity to the organ support system of the present disclosure in preparation for step 900d. Step 900c can additionally include positioning the organ support system in an open configuration ready to receive the organ.

In FIG. 9D, a step 900d can include inserting the organ (e.g., kidney) into a constituent portion of the organ support system. The organ can be placed into one of the shell halves, for example the lower shell half with the organ positioned in the indicated orientation following the orientation markers. For example, for a kidney, the ureter can be aligned with an orientation arrow showing the optimal position of the kidney within the organ support system.

Following step 900d, an additional step of maintaining the kidney temperature between 1° C. and 7° C. can be included in the method of preparing an organ-preservation housing. In some examples, this step following 900d can be for at least 30 minutes. In other examples, this step following 900d can maintain the kidney temperature for at least 45 minutes. In still other examples, this step can maintain the kidney temperature for at least 60 minutes. In some examples, the step following 900d can maintain the kidney temperature for at least 90 minutes. In some examples, the packaging system for pre-cooling an organ-preservation housing can further include an insulated transport sleeve. In particular examples, the insulated transport sleeve can be configured to maintain the package below 4° C. for at least two hours during hand-off from the donor operating table to the recipient operating table. Additionally or alternatively, in some examples, packaging system for pre-cooling an organ-preservation housing can further include one or more frozen phase-change packs surrounding the tray. In these examples, at least one of the insulated transport sleeve or one or more frozen phase-change packs surrounding the tray can insulate the package, maintaining the cooled temperature of the tray, the organ preservation housing, and the organ.

In FIG. 9E, a step 900e can include closing the organ support system (e.g., inserting oblong wall members into endcap wall members) to substantially enclose the organ. Step 900e can include ensuring contact of the oblong wall members with the organ.

In FIG. 9F, a step 900f can include securing attachable strap members in place to provide a secured configuration of the organ support system. In some examples, the attachable strap members can be secured in an “X” pattern. In particular examples, the attachable strap members can be secured snugly without compressing or without unduly compressing the organ. In some examples, once the attachable strap members are secured, the tethered structure may be tightened as needed around the organ for additional support. Upon completion of the step 900f, the organ support system is ready for subsequent procedures steps (e.g., anastomosis) discussed briefly below in relation to FIG. 10.

FIG. 10 illustrates an example method flow of utilizing an organ support system in accordance with one or more examples of the present disclosure. While FIG. 10 illustrate processes, acts (or steps) according to one embodiment, alternative embodiments may omit, add to, reorder, and/or modify any of the acts shown in FIG. 10. The processes of the workflow in FIG. 10 can be performed as part of a method. Alternatively, a non-transitory computer-readable medium can comprise instructions that, when executed by one or more processors, cause a computing device (or a computer component, such as a processor, implemented on or in communication with a robotic apparatus) to perform the acts of FIG. 10. In some embodiments, a system can perform the acts of FIG. 10.

As shown, FIG. 10 includes a transplantation workflow 1004, comprising branched processes 1006, 1008, 1010, 1012 that can be performed by a robot 1000 and/or a surgeon 1002. The workflow 1004 an initial workflow 1014 that includes preparing the patient for the procedure 1016, which may positioning of the patient, sterilizing and draping of the operative site, and achieving anesthesia. Once prepped, the operative procedure may begin, with the initial incision 1018, and isolation of vasculature in preparation for anastomosis of the donor kidney 1020. In parallel or conjunction, the workflow 1004 can include a workflow 1006 (discussed above in relation to FIGS. 9A-9F) for positioning a donor kidney within an organ support system of the present disclosure. The donor kidney can thus be maintained at a cooled temperature during the subsequent acts. Although not expressly shown, the set of acts 1006 can include suspending the organ support system (with the donor kidney) above the patient or immediately proximate to the iliac vein and iliac artery. Alternatively to suspension in air, the organ support system (with the donor kidney) can be laid to rest on top of the patient adjacent to the surgical site. The workflow 1006 includes removal of the kidney support device from the freezer 1024, opening and placing the sterile contents of the device packaging onto the sterile field 1026, and placing the donor kidney into the kidney support device 1028, before the prepped kidney is brought into the surgical field 1022.

Following initial patient preparation 1014 and donor kidney preparation 1006, the venous anastomosis workflow 1008 can be performed. In this workflow 1008, the iliac vein is initially clamped 1030, and an opening cut is made on the iliac vein 1032. Corner suture stitches are placed on the cut 1033. The combined kidney and kidney support device is then brought close to the anastomosis site 1034 (whether suspended in air or laid/supported on the patient), and the renal vein is attached to the iliac vein with corner stitches placed on the cut 1035 to complete the venous anastomosis 1036. Next, the arterial anastomosis workflow 1012 is started, with the clamping of the iliac artery 1040, followed by an incision into the iliac artery 1042. The renal artery is then sutured to the iliac artery to complete the arterial anastomosis 1044. At that point the kidney support device can be separated from the kidney, and the kidney support device may then be removed from the surgical field 1046 and disposed 1048. Next, the ureteral anastomosis workflow 1012 is started, with removal of the clamps of the iliac vein and artery 1050. The bladder is filled with saline 1052, and the ureter of the donor kidney is sized and trimmed 1054 to an appropriate length. The bladder is opened 1056 and the ureter is then sutured to the bladder 1058. Once the ureteral anastomosis is completed, closure of the surgical site is performed 1060 to complete the procedure 1062.

Upon completion of the set of acts 1006, the donor kidney can be dropped or otherwise placed into the patient by performing acts 1010 discussed above in relation to FIGS. 1A-1C (e.g., removing the attachment strap members from their secured configuration and allowing the constituent portions to radially rotate away from the proximal opening). Additionally or alternatively, the acts 1010 can include pulling the organ support system apart via application of separating forces at handles attached to the organ support system (e.g., handles 134). Post-anastomosis steps 1012 can then be performed for completion of the series of transplantation acts 1004.

For a robotic iliac-fossa transplantation the charged kidney support assembly is opened on the back table while pneumoperitoneum is being established and the recipient's iliac vessels—or other planned anastomotic site—are exposed in the usual manner. When the team is ready to proceed, and with the device still resting in its sterile tray, the surgeon (or scrub nurse under direct vision) withdraws the frozen color temperature insert or component, verifies that the indicator liquid is uniformly blue, and immediately lowers the ice-slush-cooled kidney graft into the inferior green shell. The ureter is aligned with the yellow orientation arrow at the lower pole; the superior white shell is folded over and nested into the inferior shell, and the two hook-and-loop straps are crossed in an X-pattern tight enough to close the overlap margins without parenchymal compression. Total bench exposure is typically less than ninety seconds, after which the loaded kidney support assembly—now weighing approximately 250 g including graft and residual PCM—is brought to the operative field.

The assembly is delivered into the abdomen through the wound retractor or gel port exactly as a conventional graft would be introduced. A laparoscopic grasper may first engage the lanyard to guide the organ into the pelvis; once inside the insufflated cavity robotic arm A advances a 10 mm (or comparable) grasper to seize the suspension lanyard situated opposite the hilar window, thereby orienting that window laterally with the renal vein directed toward the iliac vessels. Either the lanyard or the closed lateral loops may be grasped—the continuous-ring geometry prevents accidental disengagement and facilitates tool purchase. Single- or dual-arm control stabilizes the housing and positions the hilum precisely without the need for an assistant.

Venous and arterial anastomoses are performed while the latent heat of fusion stored in the shell-embedded phase-change material maintains cortical temperature between about 1° C. and 7° C. for at least sixty minutes under 12-14 mm Hg insufflation and 22-25° C. ambient conditions. To mitigate cortical bleeding on reperfusion, hemostatic adjuncts such as oxidised regenerated cellulose may be packed around the graft before it is enclosed in the kidney support assembly; the compliant foam shells conform without occluding the hilar window. When vascular suturing is complete, the straps are peeled away with robotic forceps; alternatively they may be transected with robotic scissors, the severed ends remaining conspicuous because each strap tip contains a radiopaque filament. Detaching both straps leaves the shell halves connected only by the lanyard; lifting the lanyard in the +Z direction allows gravity and the intrinsic mass of each half to swing them radially apart, unveiling the kidney while avoiding vertical compression or traction on the freshly sewn vessels. The graft may then be rotated laterally into its definitive retroperitoneal position before ureteroneocystostomy is commenced.

The now-empty kidney support assembly is grasped by its lanyard and withdrawn through the same gel port, completing device removal in less than thirty seconds. Ureteral anastomosis and fascial closure then follow standard robotic protocols. All disposable components—including shells, straps, lanyard, and spent temperature color insert—are discarded as regulated medical waste. In some examples, a temperature indicator can be included on the inner surface of the kidney support assembly to provide an indication of temperature of the kidney following the venous and arterial anastomoses. Extended cold-chain hand-off, alternative eutectic PCM chemistries melting between about −2° C. and +5° C., and substitute loop geometries (e.g., stainless-steel eyelets or reinforced polymer rings) are expressly contemplated, provided they satisfy latent-heat, biocompatibility, and dimensional constraints (no more than 5 mm added wall thickness for integrated sensors, LEDs, or BLE telemetry modules).

Although described principally in the context of kidney transplantation, the devices and methods disclosed herein may be applied to other solid organs—including heart, lung, liver and pancreas—to vascular grafts, extremities, heart valves and other tissues, and to xenotransplants such as porcine grafts. The devices may likewise be employed during partial nephrectomy, for cooling preservation solutions during procurement, or for protecting temperature-sensitive fluids, blood products, plasma or medications at any stage from donor surgery through recipient implantation.

A sterile kidney support assembly is supplied within a Tyvek® pouch with peelable seal per ISO 11607. In some examples, the Tyvek® pouch can be configured to lie flat against the package, if a bulge is present, the package may not be suitable for use. The kidney support assembly can be sterilized using many various known techniques, including gamma irradiation. In some examples, the Tyvek® pouch is over-packed in an insulated sleeve that contains two frozen phase-change bricks; the assembly comprises a two-shell housing pre-loaded with a frozen Cool-Bean™ insert, two pre-attached hook-and-loop straps, two spare straps and a data-collection sheet. Upon receipt the transplant coordinator inspects sterile indicators, verifies package integrity and stores the sleeve flat at −20° C. for no less than twenty-four hours. While charging, the Cool-Bean insert solidifies; a food-grade dye dispersed within the insert turns intense blue at or below 0° C., providing an unequivocal visual indication that both insert and housing are fully charged.

Immediately before vascular anastomosis the circulating nurse retrieves the insulated sleeve from the freezer, peels the Tyvek® lid and deposits the inner tray directly onto the sterile field, maintaining the tray horizontal so intimate thermal contact between insert and housing remains undisturbed. The scrub nurse removes the transparent tray cover by pulling four tabs, then optionally flexes each foam shell once along its mould parting line, an elastic manoeuvre that enhances conformability around unusually bulbous grafts without compromising structural integrity. With the Cool-Bean insert still inside the cavity the operator confirms that the indicator liquid is wholly blue and that no pink or colourless zone is present. At the surgeon's command the insert is withdrawn by its colour-coded tab and discarded into a sterile basin; removal marks time zero of a validated sixty-minute thermal budget.

The kidney, freshly removed from slush after back-table preparation, is immediately lowered into the green inferior shell. The ureter is aligned with a yellow arrow and ureter label at the lower pole. The white superior shell is folded over and nested into the inferior shell. Two hook-and-loop straps are crossed in an X-pattern tight enough to close overlapping margins yet loose enough to avoid parenchymal compression; the fixed hilar window remains unobstructed. If desired the artery may be tucked temporarily inside the kidney support assembly while the vein is sewn first, or vice versa. Initial sutures may be placed while the kidney and kidney support assembly remain in the tray, stabilizing the graft before it is lifted into the operative field.

During open surgery the suspension lanyard affixed to the superior shell margins is clamped to a table-mounted arm, suspending the kidney support assembly so gravity keeps the hilum dependent and freeing the assistant's hands. Alternatively, the kidney support system assembly can be laid adjacent to the surgical site and oriented for ease of surgical access. Fine adjustment of lanyard tension modulates graft height relative to the iliac vessels; in certain embodiments the lanyard may be shortened or removed at the surgeon's discretion. Throughout venous and arterial anastomosis the latent heat of fusion stored within the shell-embedded PCM maintains cortical temperature between approximately 1° C. and 7° C. under 22-25° C. ambient conditions. Optional radiopaque markers in the lanyard buckle, straps and shell rims permit fluoroscopic confirmation that no device component remains in the field. Upon reperfusion the straps are peeled free; without the straps the paired shells are connected only by the lanyard, and gravity causes them to swing radially apart, unveiling the kidney while avoiding vertical compression or traction on the vascular sutures. The lanyard is then lifted clear and the empty shells are withdrawn en bloc and discarded as regulated medical waste. Ureteral implantation and fascial closure proceed per standard practice; all disposable components—including shells, straps, insert, inner tray and spent PCM bricks—are disposed of according to institutional biohazard protocols, whereas the insulated sleeve may be recycled if clean.

Extended cold-chain hand-off is accommodated because the insulated sleeve maintains the charged assembly below 4° C. for at least two hours, enabling transport from an off-site freezer to the operating theatre without supplemental ice. Equivalent performance is achieved with any eutectic PCM melting between about −2° C. and +5° C. and possessing latent heat of fusion not less than 200 kJ kg⁻¹. Closed EVA-plastic rings are preferred as graspable loops, yet stainless-steel eyelets, reinforced polymer loops and analogous geometries are fully contemplated. Temperature sensors, LEDs, timers and Bluetooth-Low-Energy telemetry modules may be encapsulated within either shell or the handle plate, provided they add no more than five millimeters of wall thickness and meet biocompatibility requirements.

| Step | Actions & Checks |
|---|---|
| Charge & Stage | Verify the sterile shipping sleeve is intact. Store entire sleeve flat at −20° |
| Device (−24 h → | C. ≥ 24 h. Confirm coolant-indicator window shows blue before use. |
| 0 h) | |
| Bench Preparation | Remove sleeve from freezer once pneumoperitoneum & iliac-vessel |
| (≈90 s window) | exposure are complete. Peel Tyvek ® lid; present inner tray to scrub nurse. |
| | Withdraw temperature sensor insert; verify liquid indicator remains blue. |
| | Place prepared kidney into green inferior shell; align ureter with yellow |
| | arrow. Fold white superior shell over; cross both straps in “X”-snug, no |
| | parenchymal blanching. |
| Introduce Loaded | Deliver assembly through retractor/gel port exactly as with a standard |
| Pod | graft. Laparoscopic grasper may steady the lanyard during passage. |
| Primary Robotic | Robotic Arm A (10 mm grasper) grasps suspension lanyard opposite hilar |
| Engagement | window. Dial the pod so the hilar window faces laterally; renal vein aimed |
| | at iliac vein. If preferred, Arm B grips either lateral closed loop for dual- |
| | arm stabilization. Continuous-ring geometry prevents drop-out. |
| Fine | Optional: pack oxidized cellulose or alternative hemostatic agent around |
| Positioning & | cortex before closing kidney support assembly or pod if high-risk bleeding |
| Optional | anticipated. Seat pod in true iliac-fossa position; confirm no tension on |
| Hemostasis Prep | lanyard or loops. |
| Vascular | Perform venous then arterial suturing in usual sequence. PCM maintains |
| Anastomoses | graft cortex 1-7° C. for ≥60 min at 12-14 mm Hg pneumo. Monitor |
| (≤60 min target) | surface color & hemostatic adjuncts. |
| Strap Release | Option A (preferred): Arm B uses Maryland forceps to peel distal strap |
| | tab → proximal, repeat for second strap. Option B: Transect straps |
| | with robotic scissors; radiopaque tips remain visible for retrieval. |
| Radial Pod | With both straps detached, shells are linked only by lanyard. Arm A lifts |
| Opening & Graft | lanyard +Z ≈ 3-5 cm; gravity swings shells radially apart (θ ≈ 40°). Verify |
| Unveiling | vessels are free of compression; remove oxidized cellulose if used. |
| Final Pod | Rotate graft to retroperitoneal bed as per surgeon preference. Grasp |
| Extraction | lanyard with laparoscopic or robotic grasper. Withdraw empty pod |
| | through original gel port; discard to biohazard. |
| Completion | Perform ureteroneocystostomy and fascial closure per standard robotic |
| | protocol. Dispose of shells, straps, lanyard & spent temperature sensor, |
| | record anastomosis time & temperature log (if telemetry used). |

In describing representative examples, the specification may have presented the method or process as a particular sequence of steps. To the extent that practice of the method does not rely upon that specific order, the claimed method should not be limited by the sequence recited. One of ordinary skill in the art will recognize that equivalent or additional steps may be employed, that certain steps may be omitted, or that the order may be rearranged without departing from the invention. Accordingly, the particular order in which steps are described should not be construed as a limitation on the claims.

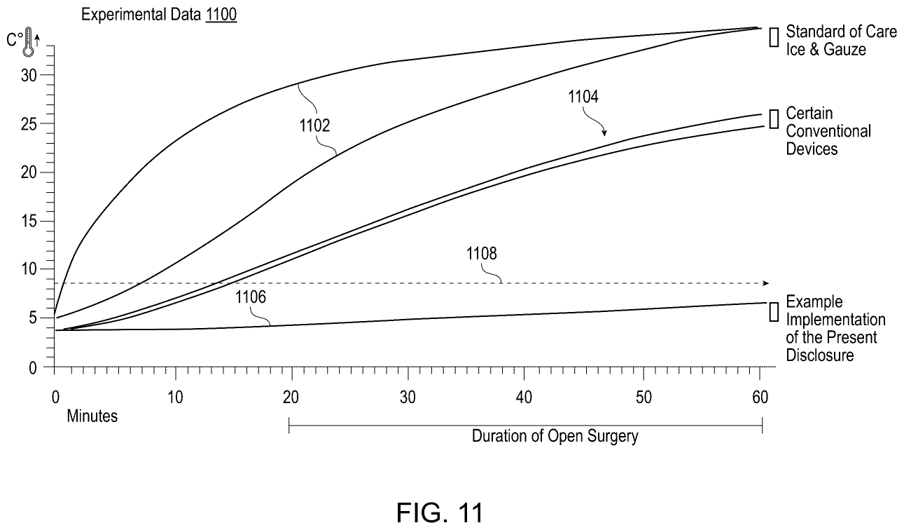

FIG. 11 illustrates—in relation to the current standard of care and certain conventional devices—experimental data 1100 of utilizing an organ support system in accordance with one or more examples of the present disclosure. As shown, the experimental data 1100 illustrates a chart with a temperature axis (Y-axis) in degrees Celsius and a time axis (X-axis) in minutes. There are three sets of lines that depict organ (Kidney) temperature as a function of time. Each set of lines is also shown relative to a threshold temperature 1108 of 7 degrees Celsius.

The first set of lines 1102 corresponds to the current standard of care using ice and gauze wraps around the kidney. The experimental data 1100 indicates that kidney temperature under the current standard of care rapidly (e.g., in under 10 minutes) surpasses the threshold temperature 1108.

The second set of lines 1104 corresponds to certain other experimental devices used to cool a donor kidney. These experimental devices can provide a temperature improvement to the donor kidney relative to the current standard of care. However, the kidney temperature surpasses the threshold temperature 1108 within approximately 15 minutes.

The third line 1106 corresponds to the kidney temperature of a donor kidney continuously cooled using the organ support system of the present disclosure. The kidney temperature indicated in the third line 1106 is maintained below the temperature threshold for an entire duration of the transplant procedure.

In some examples, the organ support system of the present disclosure can thus significantly reduce warm ischemia time. Studies have shown that limiting warm ischemia time to less than 30 minutes can reduce the risk of DGF by 3.5-fold. Furthermore, elimination of warm ischemia by graft cooling during implantation to a temperature of 4° C. results in a reduction of metabolism to 5-8% in the majority of cells, diminished enzyme activity, and mitigate ischemic injury. The organ support system of the present disclosure can thus reduce the rate of DGF and improve allograft function.

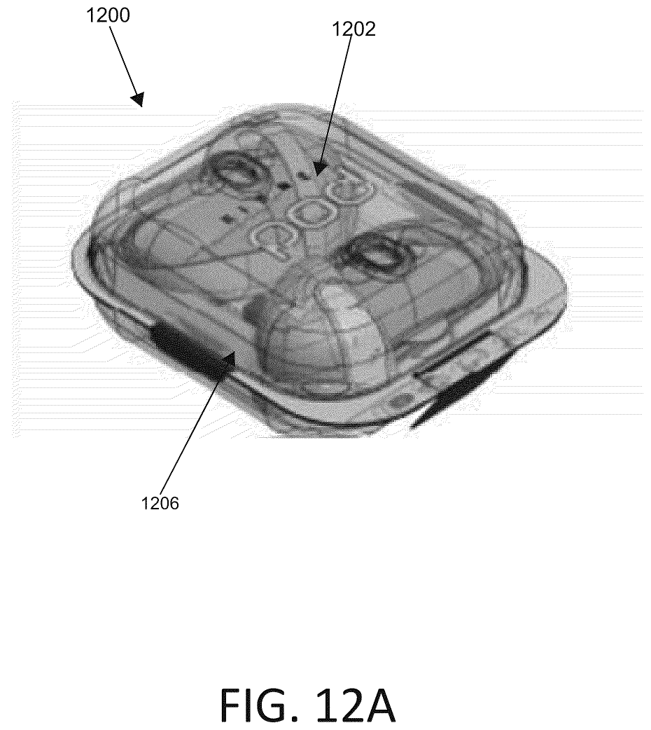

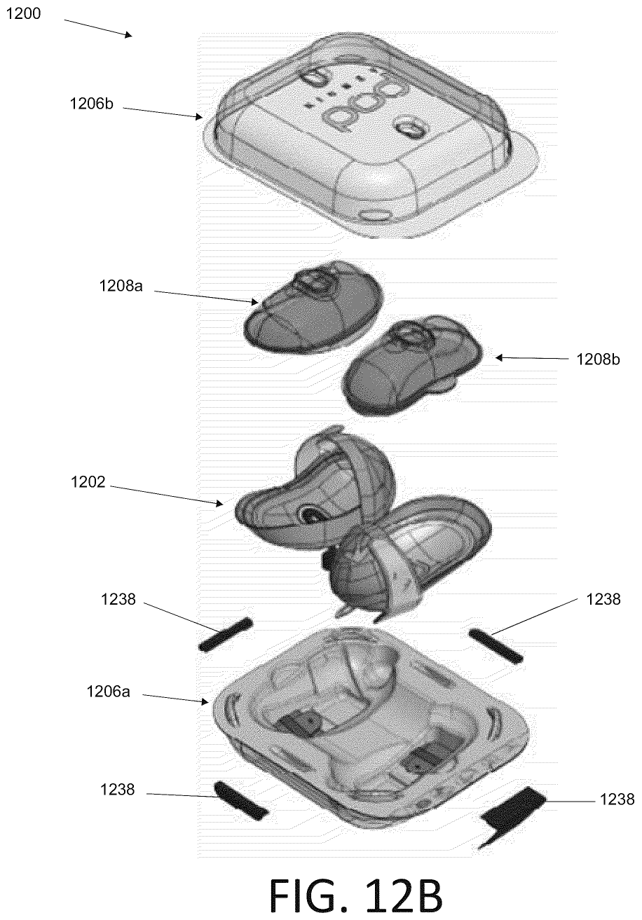

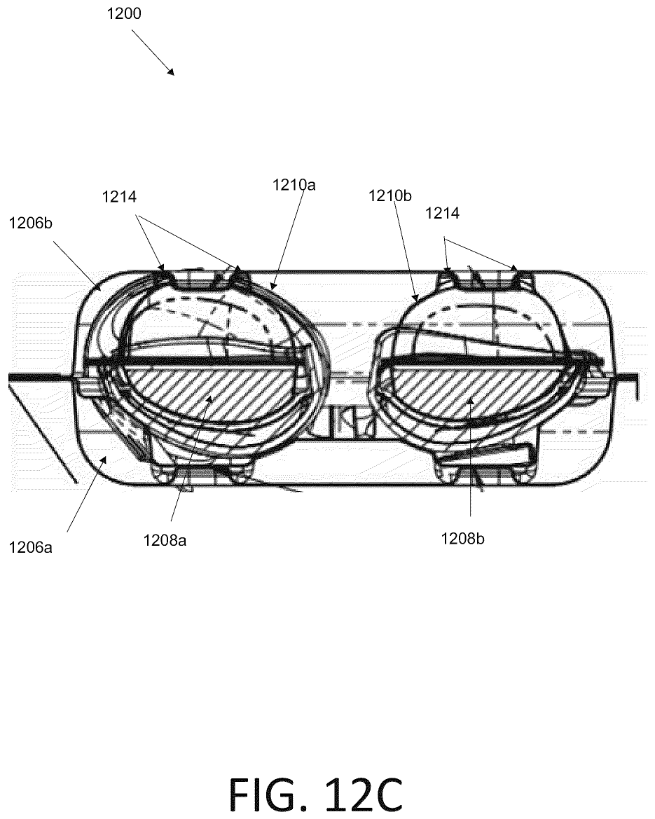

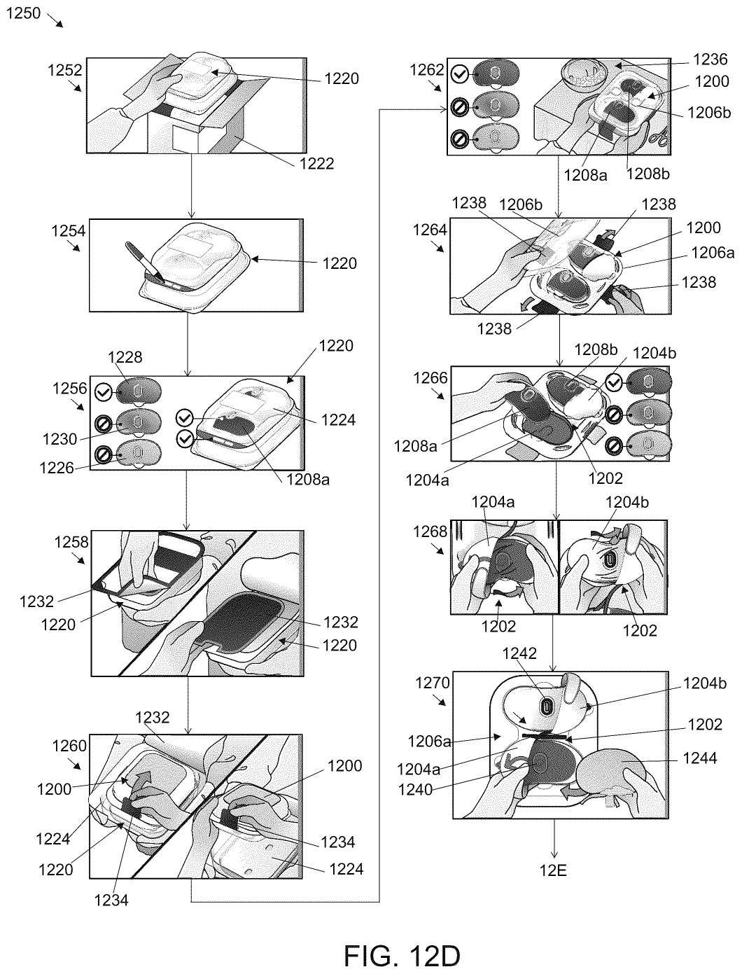

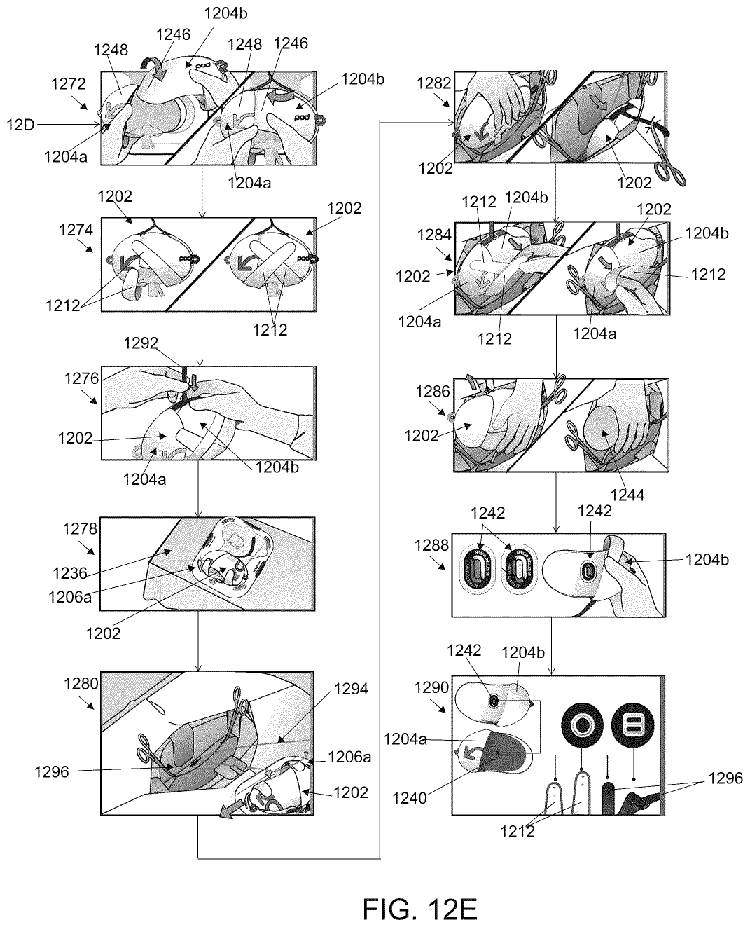

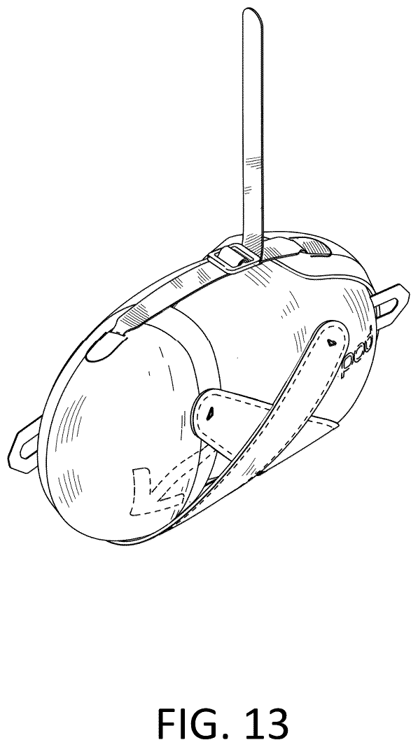

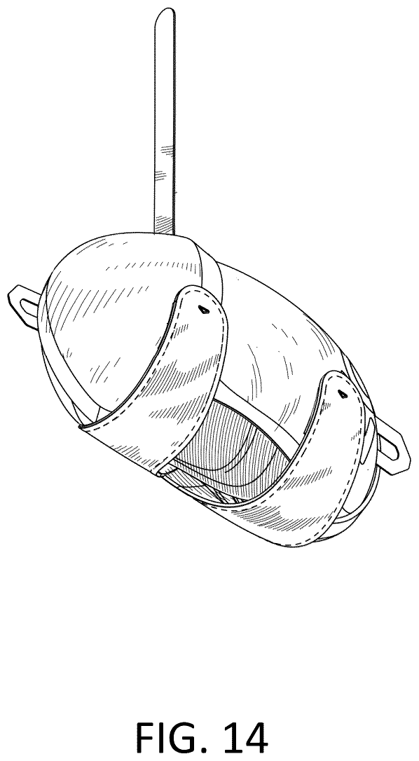

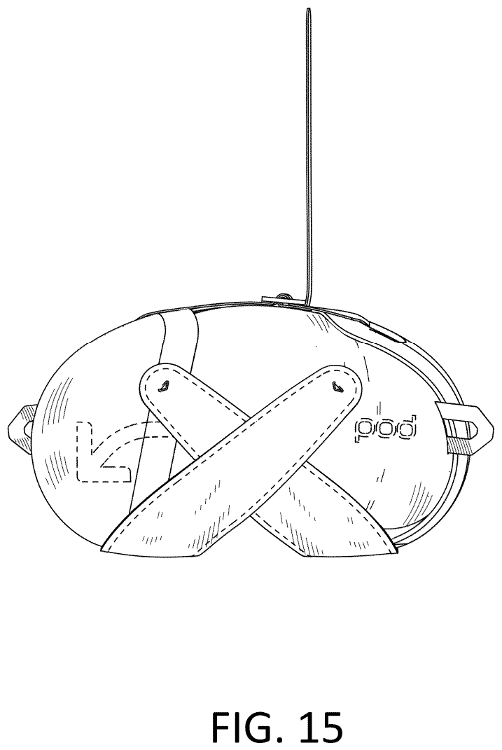

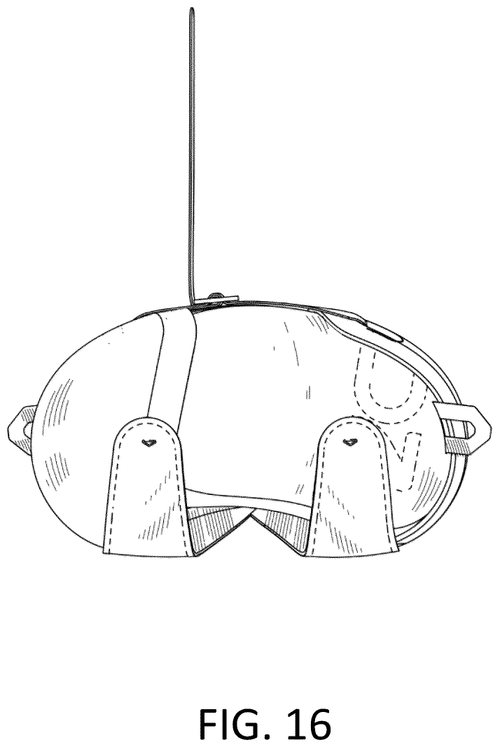

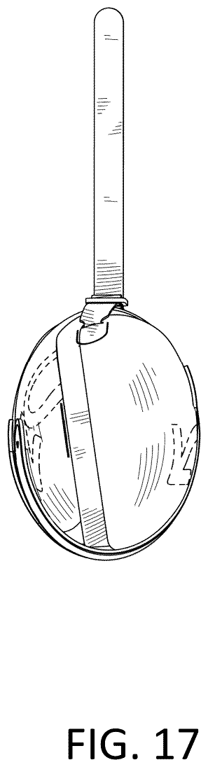

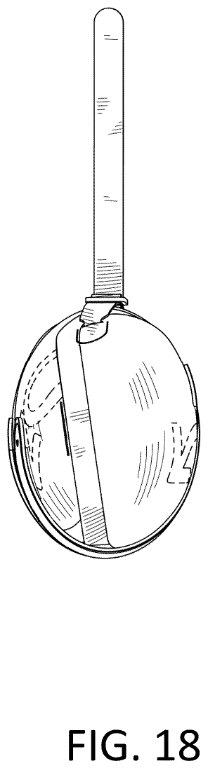

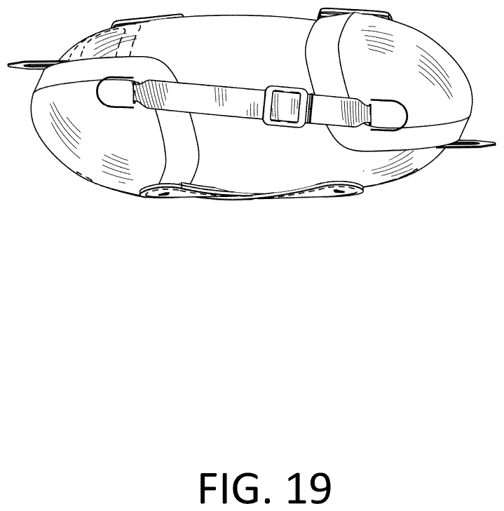

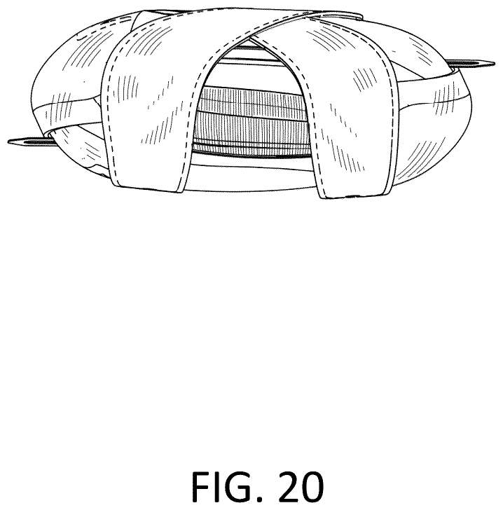

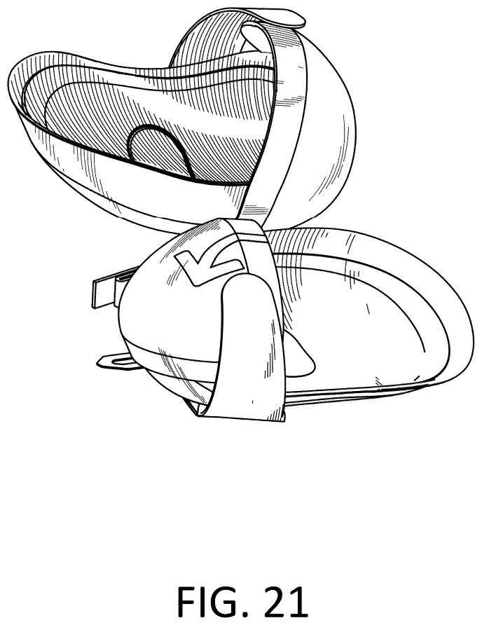

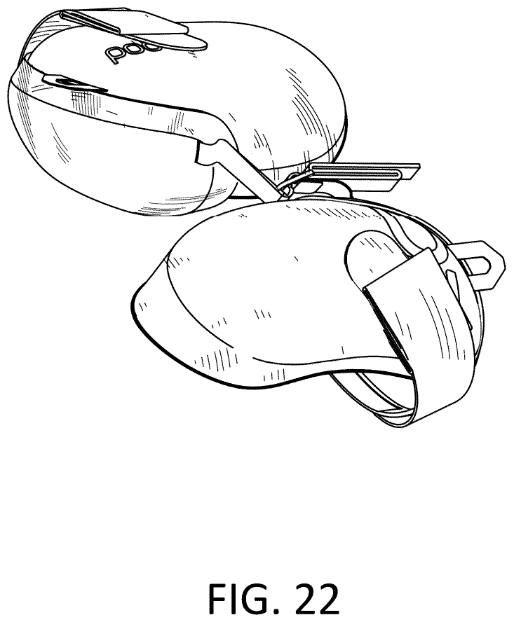

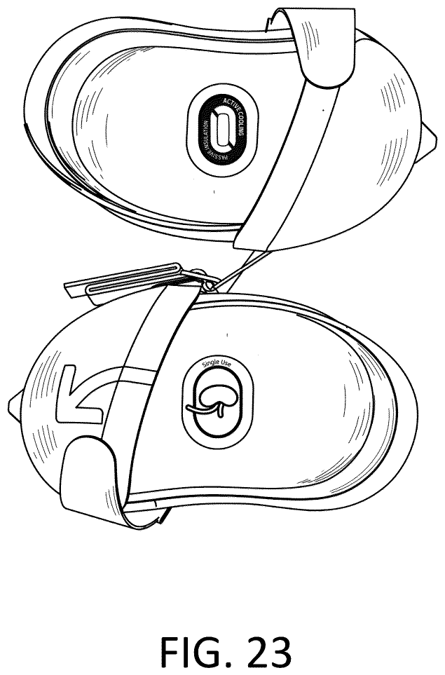

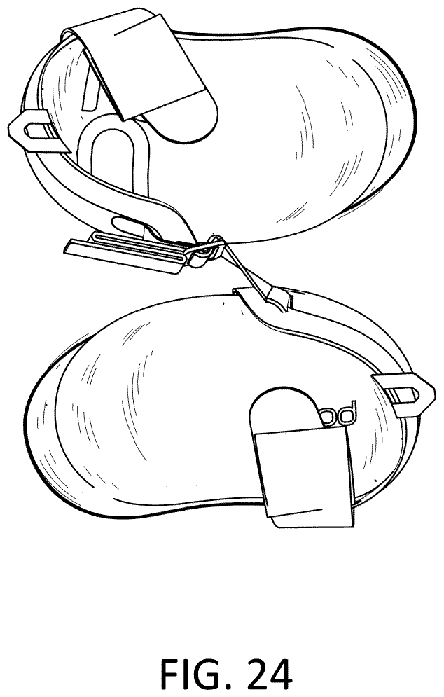

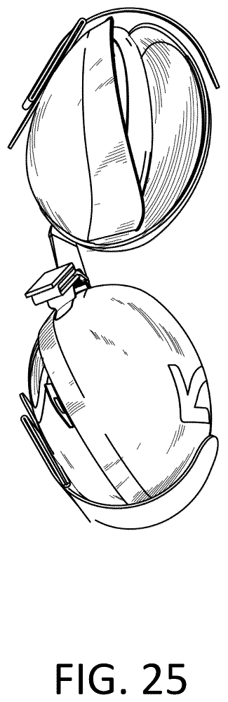

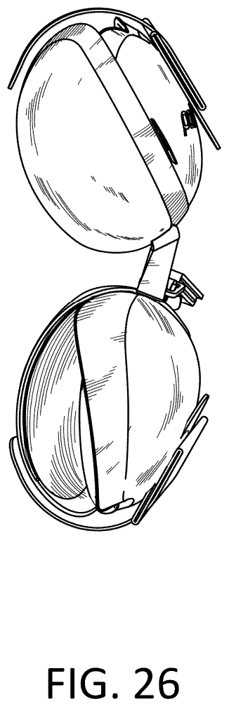

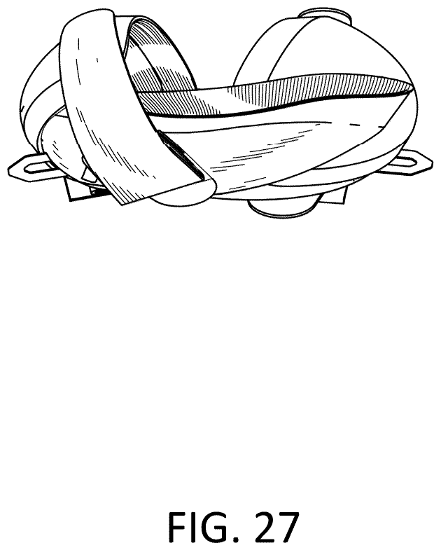

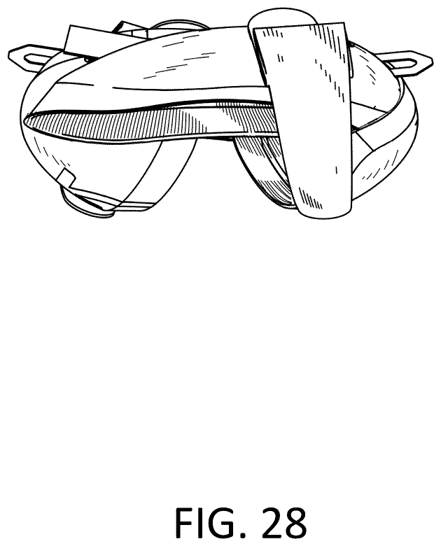

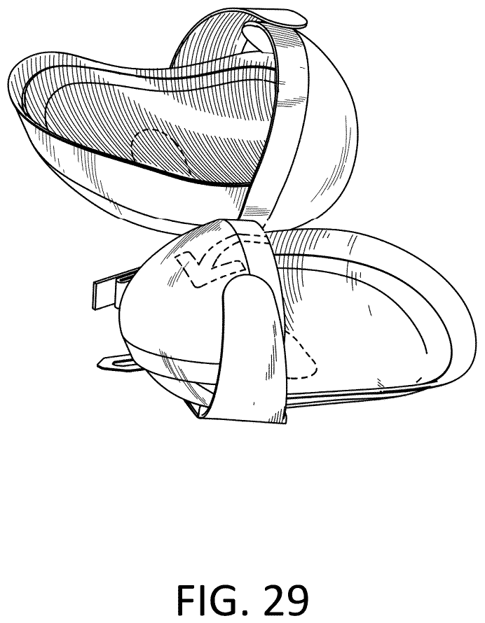

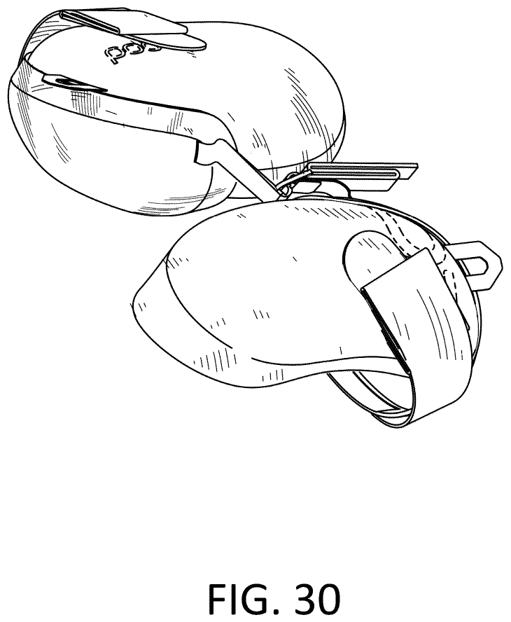

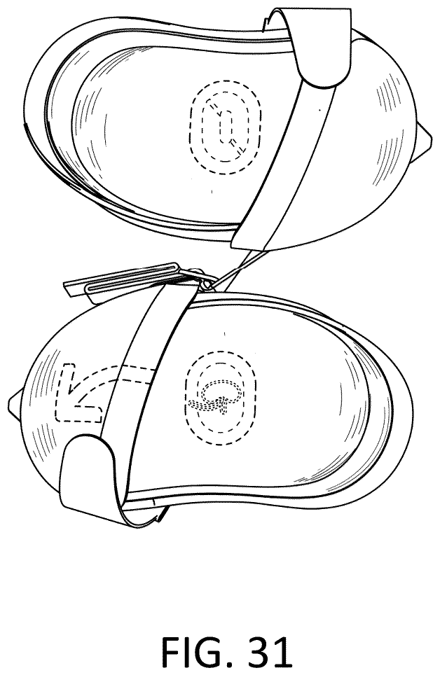

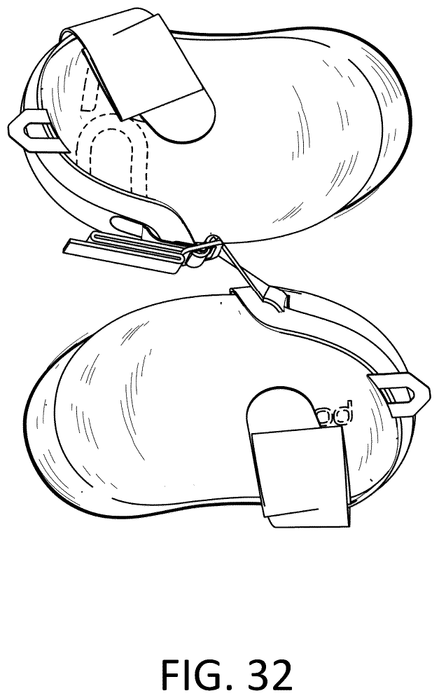

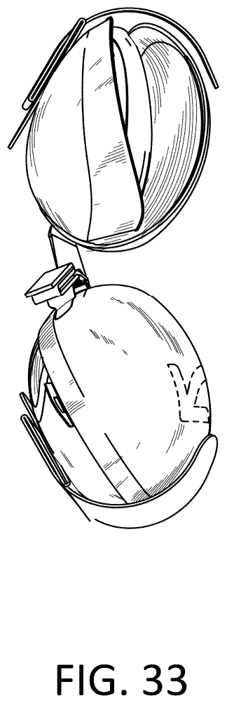

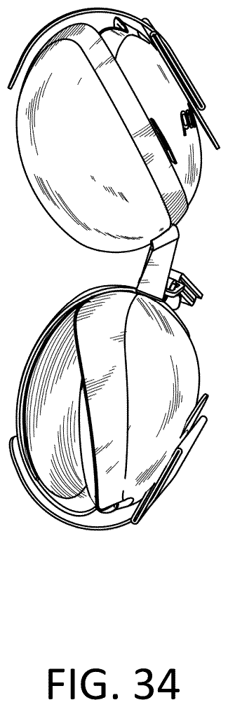

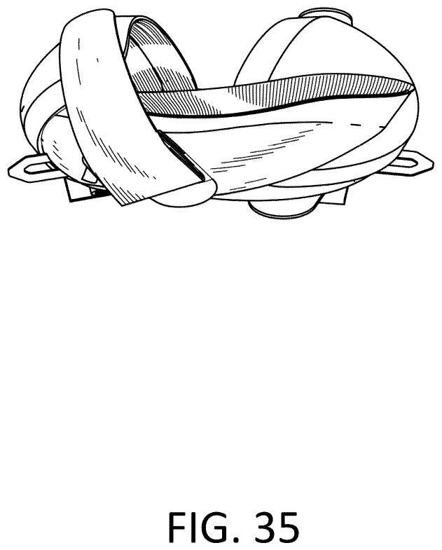

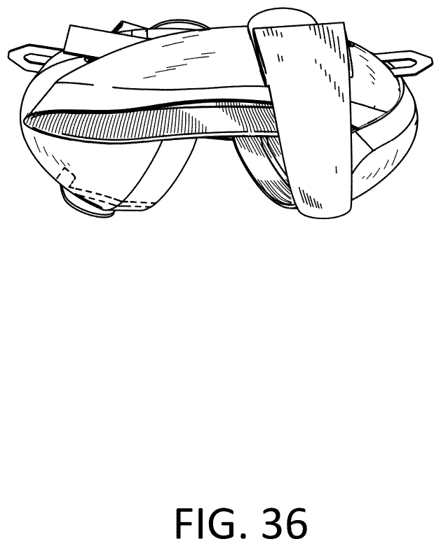

FIG. 12A illustrates a package 1200 or packaging system including an organ preservation device 1202 of the present disclosure as described in detail above. The package 1200 includes an organ preservation device 1202 enclosed in a 206a and tray lid 1206b. Similarly, FIG. 12B illustrates an exploded version of a package 1200 or packaging system including of the present disclosure. The exploded version illustrates the cooling inserts 1208a, 1208b which further maintain the temperature of the preservation device 1202 until the preservation device 1202 is ready for use. Finally, FIG. 12C illustrates a cross-section of the package 1200 including the organ preservation device 1202. In some examples, the first compartment 1210a of the tray 1206a can be form molded to mirror the design of the organ preservation device 1202. For example, FIG. 12C illustrates a cross-sectional view of an example tray 1206a molded to fit around the attachable strap members 1212 in a folded configuration. In this example, the organ preservation device 1202 can rest more securely within the tray with minimal rotation or translation of the organ preservation device 1202 within the tray 1206a. Similarly, the first and second compartments 1210a,b of the tray 1206a can have complementary interfit or keying features 1214, e.g., complementary ridges and recesses, that correspond with the features of the organ preservation device 1202, or other similar features to reduce shifting and/or jostling of the organ preservation device 1202 within the tray 1206a during use.

In one exemplary embodiment, illustrated in FIGS. 12D and 12E, a method 1250 for preparing and using the preservation device is provided. The non-sterile outer casing 1220 is removed from its shipping container 1222 and inspected for package integrity (1252). The date and time may be written on the outer casing 1220 before being placed in a −20 C freezer for at least 24 hours (1254). In some variations, the outer casing 1220 should be kept in the freezer in a generally horizontal orientation, though in some variations, tilting up to 45 degrees is permitted. It is believed that the generally horizontal position will facilitate more consistent freezing of the housing components inside the casing 1220, whereas storage in a vertical position may result in uneven freezing between the different housing components.

Following at least 24 hours of cold storage of the casing 1220, in preparation for the kidney transplantation surgery, the casing 1220 is retrieved from the freezer and the temperature indicator is checked through the optically clear shell 1224 of the casing 1220 (1256). In this example, the color of the cooling insert 1208a contained in the casing 1220 and package 1200 is visible and can confirm whether the package 1200 has achieved the target temperature, resulting in a complete color change from a first color (e.g., pink 1226) when the outer packaging 1220 was at room temperature or at least above the target temperature, to a second color (e.g., blue 1228), indicating that the cooling inserts 1208a and the preservation device are fully at or below the target temperature. If no color change or only partial color change (1230) are found, the outer packaging 1220 and/or freezer status should be re-evaluated.

Referring still to FIG. 12D, using sterile technique, the outer case 1220 should be flipped over and using sterile technique, the lid 1232 of the outer casing 1220 should be peeled back or removed (1258). The sterile package 1200 is removed, utilizing an optional pull tab 1234 that is attached to the tray of the package 1200 to facilitate the lifting of the package 1200 from the outer casing 1220 (1260). The package 1200 is then kept in the sterile field 1236 until ready for use (1262), with continued temperature monitoring of the cooling inserts 1208a,cb through the optically clear lid 1208b of the package 1200. Because the cooling inserts 1208a,b of the package 1200 provides additional cooling to the preservation device 1202, the preservation device 1202 should not be removed from the package 1200 until ready for use.

When the kidney or other organ is ready to begin the anastomosis or transplant procedure, the lid 1206b of the package 1200 is removed or separated from the tray 1206a (1264). The one or more retention latches or stickers 1238 should be separated or peeled away from the lid 1206b during lid 1206b separation.

With the preservation device 1202 and cooling inserts 1208a,b now exposed, the thermal readiness of the preservation device 1202 and cooling inserts 1208a,b should be re-assessed to ensure cooling performance (1266). Once confirmed, the cooling inserts 1208a,b should be removed from the shell portions 1204a,b of the preservation device 1202, exposing the concave inner surfaces of the shell portions 1204a,b, including the temperature indicator coupled to one or more shell portions 1204a,b. Preferably, the same temperature indicator type is provided for consistency between the inserts 1208a,b and those provided on one or more shell portions 1204a,b. The nominal cooling time of the preservation device 1202 may also be marked or initiated once the lid 1206b is removed. In some variations, this cooling time may be 60 minutes, but in other variations, the cooling time may be nominally up to 30 minutes, 35 minutes, 40 minutes, 45 minutes, 50 minutes, 55 minutes, 65 minutes, 70 minutes, 75 minutes, 80 minutes, 85 minutes, 90 minutes, 95 minutes, 100 minutes, or any selected range therebetween.

The shells portions 1204a,b of the preservation device 1200 may then be optionally squeezed, twisted or otherwise manipulated to reduce rigidity and/or improve flexibility or conformity of the preservation device 1202 to the organ (1268). The preservation device 1202 is then placed back in the tray 1206a, with each shell portion 1204a,b oriented with its concave surface facing upward, each with its indicia 1240 or temperature indicator 1242 visible (1270). In some variations, the shell portions may be differentiated via color, text and/or other graphical indicia or markings, and/or to indicate the orientation of the kidney or organ with use. In the example depicted in step 1270, a lower shell portion 1204a may be provided with a colored inner surface with a graphical marking 1240 depicting the kidney orientation for placement into its cavity. Once the kidney 1244 is placed in the cavity of the lower shell portion 1204a, the upper shell portion 1204b folded over to enclose the kidney 1244 between the lower and upper shell portions 1204a,b. Care should be taken to tuck the body 1246 of the upper shell portion 1204b into the end 1248 of the lower shell portion 1204a (1272). The closure straps 1212 of the preservation device 1202 are then applied in an “X” pattern, in a snug but not compressive manner (1274).

The suspension lanyard 1292 of the device 1202 is then optionally adjusted or tightened as needed, which can further tighten the shell portions 1204a,b of the device 1202 to the kidney (1276). The enclosed kidney and preservation device 1202 can then be placed back in the tray 1206a on the sterile field 1236 while the anastomosis site is prepared (1278). When the anastomosis is ready to start, index or alignment stiches 1294 may be placed at the anastomosis site 1296 to facilitate alignment of the kidney and device 1202 to the site (1280). The device 1202 may be kept in the tray 1206a at this time until suturing begins.

Once suturing is started, the kidney and device 1202 may continue to be repositioned and/or re-oriented to facilitate visibility or exposure needed to complete the venous, arterial, ureteral or other anastomoses (1282). The suspension lanyard 1292 of the device 1202 may be adjusted to retract the device 1202 from the site as needed.

After completion of the anastomoses, organ reperfusion is reinitiated to confirm the integrity of the anastomoses. The release straps 1212 can then be manipulated to release the shell portions 1204a,b from each other, and thereby release the kidney 1244 or organ from the device 1202 (1284). The device 1202 can then be removed from operative field and disposed as medical waste (1286). During the procedure the temperature indicators on one or more shell portions 1204b should be continued to be monitored (1288). In this particular example, the temperature indicator 12 may be selected to indicated via a blue color that cooling is still below 12 degrees Celsius, with a color change to pink or white if temperature rises above the indicated temperature. Various radio-opaque markers may also be provided on the shell portions 1204a,b, straps 1212, and/or lanyard 1292 (1290).

In some variations, the cooling inserts may comprise the same cooling material and/or different cooling material as the shell-like cooling structures of the housing, e.g., a phase-change material. In some variations, the cooling inserts may be kidney-shaped or egg-shaped, half-kidney-shaped or half-egg-shaped, or otherwise configured to the volume and shape of the cavity formed by the housing components, its open configuration. In typical configurations the volume and/or cooling capacity of each insert may be greater than the shell-like cooling structure it is configured to be in contact with. In some further variations, the volume or cooling capacity may be between 50% to 1000%, 100% to 800%, 200% to 800%, or 300% to 100) % greater than the shell-like cooling structure that it is configured to contact.

Be it known that we, Keith S. Hansen, Darja Wendel, Elger Oberweilz, Jörg Student and Kyle Hartelt, have invented a new, original and ornamental design for a kidney support device, embodiments of which are shown in the accompanying drawings. These include but are not limited to the exemplary embodiments in FIGS. [symbol] 13-20, 21-28, and [symbol] 29-36, respectively.

The foregoing description, for purposes of explanation, used specific nomenclature to provide a thorough understanding of the described examples. However, it will be apparent to one skilled in the art-having the benefit of this disclosure—that the specific details are not required in order to practice the described examples. Thus, the foregoing descriptions of the specific examples described herein are presented for purposes of illustration and description. They are not intended to be exhaustive or to limit the examples to the precise forms disclosed.

It will be apparent to one of ordinary skill in the art, having the benefit of this disclosure, that many modifications and variations are possible in view of the above teachings. Indeed, various inventions have been described herein with reference to certain specific aspects and examples. However, many variations are possible without departing from the scope and spirit of the inventions disclosed herein. Specifically, those inventions set forth in the claims below are intended to cover all variations and modifications of the inventions disclosed without departing from the spirit of the inventions. The terms “including” or “includes” as used in the specification shall have the same meaning as the term “comprising.” Additionally, the terms “about,” “approximately,” and “substantially” should be interpreted as +/−10 percent of a stated value.

What is claimed is:

1. A packaging system for pre-cooling an organ-preservation housing, comprising:
a tray having a first compartment shaped to receive an organ preservation device and a second compartment; and
a phase-change material insert positioned in the second compartment, the removable phase-change material insert configured to transfer heat from the organ preservation device when the organ preservation device is in thermal contact with the first compartment.

2. The system of claim 1, wherein the phase-change material insert comprises a melt temperature between 3° C. and 5° C.

3. The system of claim 1, wherein the first compartment includes a thermally conductive film that is configured to at least partially contact an organ-preservation housing.

4. The system of claim 1, further comprising a sterile barrier pouch enclosing the tray.

5. The system of claim 1, wherein the tray comprises a high-density polyethylene and the phase-change material insert is removable.

6. The system of claim 1, further comprising an insulated transport sleeve containing one or more phase-change material inserts surrounding the tray.

7. A kit comprising the packaging system of claim 1, the organ-preservation housing, and at least one closure strap.

8. A method of preparing an organ-preservation housing, comprising:
(a) placing an organ-preservation housing in thermal contact with a phase-change material insert within a tray;
(b) waiting a dwell time until a temperature indicator confirms the organ-preservation housing temperature is 6° C. or lower;
(c) transferring a kidney into the organ-preservation housing; and
(d) closing the organ-preservation housing around the kidney and performing vascular anastomosis.

9. The method of claim 8, wherein step (b) comprises a dwell time of 5 to 10 minutes.

10. The method of claim 8, further comprising removing the phase-change material insert from the tray after step (b).

11. The method of claim 8, wherein the organ-preservation housing maintains the kidney temperature between 1° C. and 7° C. for at least 60 minutes following step (d).

12. The method of claim 8, further comprising confirming a color change of a thermal-battery indicator prior to step (c).
